(19) United States
(12) Patent Application Publication
(10) Pub. No.: US 2010/0067356 A1
(43) Pub. Date: Mar. 18, 2010

(54) OPTICAL ELEMENT FOR OPTICAL PICKUP DEVICE, OPTICAL PICKUP DEVICE AND METHOD FOR ASSEMBLING OPTICAL PICKUP DEVICE

(76) Inventors: Hideyuki Fujii, Saitama (JP); Kohei Ota, Tokyo (JP); Tohru Kimura, Tokyo (JP); Kentarou Nakamura, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/519,718

(22) PCT Filed: Dec. 7, 2007
(86) PCT No.: PCT/JP2007/073662

§ 371 Date: Jun. 17, 2009

(30) Foreign Application Priority Data
Dec. 20, 2006 (JP) JP2006-342676

(51) Int. Cl. G11B 7/135

(52) U.S. Cl. 369/112.24; G9B/7.112

(57) ABSTRACT

An optical element for an optical pickup device which can record and/or reproduce information interchangeably with an optical disc while correcting coma satisfactorily, and a compact optical pickup device employing that optical element and exhibiting excellent energy saving. In the optical element for an optical pickup device where a first objective lens portion and a second objective lens portion are formed integrally, one of the first objective lens portion and the second objective lens portion satisfies a relation |HCM|/|TCM|<0.3 and the other satisfies a relation |HCM|/|TCM|>0.3. The HCM represents the third-order angle of view coma sensitivity in the first objective lens portion or the second objective lens portion, and the TMC represents the third-order inclination angle coma sensitivity in the first objective lens portion or the second objective lens portion.

### TECHNICAL FIELD

The present invention relates to an optical element for an optical pickup apparatus, the optical pickup apparatus employing the optical element and a method of assembling the optical pickup apparatus which can conduct recording and/or reproducing information compatibly for different kinds of optical information recording medium (also referred to as optical disks).

### BACKGROUND ART

In recent years, investigation and development of a high density optical disc system which can conduct recording and/or reproducing information by using a blue-violet semiconductor laser with a wavelength of about 400 nm has been advanced quickly. As one example, in an optical disk, a so-called HD DVD (hereafter, referred to as HD) which conducts recording and/or reproducing information with a specification that NA is 0.65 and a wavelength of light sources is 405 nm, information of 5 to 20 GB can be recorded per one layer for an optical disk with a diameter of 12 cm. Further, as another example, in an optical disk, a so-called Blue-ray Disk (hereafter, referred to as BD) which conducts recording and/or reproducing information with a specification that NA is 0.85 and a wavelength of light sources is 405 nm, information of 23 to 27 GB can be recorded per one layer for an optical disk with a diameter of 12 cm. Hereafter, in this specification, such an optical disk is called a “high density optical disk”. In an optical pickup apparatus which can conduct recording and/or reproducing information for such a high density optical disk, an objective lens made of a glass may be used in order to obtain a good optical characteristic.

Further, under the circumstances at the present day that DVD and CD (compact disk) having recorded various information have been sold, it is desirable to enable to conduct recording and/or reproducing information properly for various types of optical disks as far as possible by a single player. Furthermore, under the circumstances that an optical pickup apparatus is mounted on a note size personal computer in many cases, it is important not only to have compatibility for plural kinds of optical disks, but also to realize a compact size.

Here, in an optical pickup apparatus, if different optical disks can be used compatibly by a single objective lens, such a structure may be desirable in a view point of realizing a compact size. However, with the consideration for the specification of a high density optical disk, it may be very difficult to realize to use an objective lens in common to the different optical disks. As a result, such a structure may increase a cost. In particular, since a light flux with the same wavelength is used for BD and HD regardless of respective protective substrates different in thickness, aberration correction cannot be conducted by the use of a diffractive structure. Therefore, actually, it may be difficult to use an objective lens in common to the different optical disks.

Further, a DVD/CD compatible lens has been already put in practical use for compactification. However, since a WD (working distance) of CD must be secured to some extent and an effective diameter of DVD becomes larger than that of CD, the outside diameter of a compatible lens tends to become larger due to these causes. On the other hand, if an exclusive lens is used for DVD and CD respectively, the lens for DVD can be made small regardless of the limitation on the WD of the CD side. However, if two lenses are employed, an actuator becomes large in size and a moving section becomes heavy. Therefore, there are problems that it becomes difficult to obtain high actuator sensitivity, and frequency characteristics worsen.

In order to solve the above-mentioned problems, it may be considered to use a compound optical element in which lenses are arranged in parallel and made in one body. In comparison with the case of using two lenses produced separately, such a compound optical element has a merit that the lenses can be arranged with a narrow gap between the lenses by the application of a common flange section. Further, there are another merits that the adjustment at the time of assembling can be made simple and the production cost can be made low. An example of such a compound optical element is disclosed in Patent document 1.

Patent document 1: an official report of Japanese Patent Unexamined Publication No. 9-115170

### DISCLOSURE OF THE INVENTION

### Problem to be Solved by the Invention

Here, in the case of using an optical element in which two objective lens sections are made in one body, problems occur on a coma aberration. These problems will be explained concretely with reference to FIG. 1.

For example, in FIG. 1 (a), it is presupposed that a first objective lens section OBJ1 with a larger numerical aperture NA in an optical element OE is designed to secure the performance within a diffraction limit such that spherical aberration may be corrected almost completely for a first optical disk (optical information recording medium) OD1 having a transparent substrate with a thinner thickness t1. However, due to an error in manufacturing the first objective lens section OBJ1 or an error in mounting it in an optical pickup apparatus, even if an incident parallel light flux is adjusted so as to enter vertically to a first optical disk, a coma aberration CA may occur on a converged light spot on an information recording surface of the first optical disk OD1. In this case, as shown in FIG. 1 (b), by tilting the optical element OE entirely, it becomes possible to correct the mounting error of the first objective lens section OBJ1 and the coma aberration CA owned by the first objective lens section OBJ1 itself.

On the other hand, a second objective lens section OBJ2 with a smaller numerical aperture NA in the optical element OE is designed to secure the performance within a diffraction limit such that spherical aberration may be corrected almost completely for a second optical disk OD2 having a transparent substrate with a thicker thickness t2 (t2>t1). Therefore, in the case of conducting recording or reproducing information for the second disc DSC2 having a transparent substrate with the thickness t2, a parallel light flux is made to enter into the second objective lens section OBJ2.

Here, at the time of conducting recording or reproducing information for the first disc Od1, since the optical element OE is adjusted to be tilted entirely, the second objective lens section OBJ2 made in one body with the first objective lens section OBJ1 is also tilted together with the first objective lens section OBJ1. However, since the coma aberration of the second objective lens section OBJ2 and the coma aberration of the first objective lens section OBJ1 have not always an identical property, even if they are tilted similarly, another coma aberration occurs in many cases on the second objective lens section OBJ2, (refer to FIG. 1 (c)). Thus, in a lens in which two objective lenses are made in one body, a relative tilt between two lenses cannot be adjusted. Therefore, in the case of adjusting a tilt on one lens, there is a problem that recording and/or reproducing characteristics on another lens will deteriorate. Further, in this case, in order to prevent the deterioration in recording and/or reproducing characteristics for the second optical disk OD2, it becomes necessary to tilt the optical element OE entirely in another direction in such a way that a coma aberration CA in a light spot converged on an information recording surface of the second disc OD2 becomes small. However, since the amount and orientation of the coma aberration of the second objective lens section OBJ2 depend on the coma aberration owned by the objective lens section OBJ2 itself and the correcting condition of the coma aberration CA of the objective lens section OBJ1, variation may be produced in the amount and orientation of the coma aberration of the second objective lens section OBJ2. Therefore, in order to correct the coma aberration CA of the objective lens section OBJ2, it is necessary to use a large size complicate correcting device. As a result, there is a problem that energy saving cannot be attained and miniaturization is also interfered.

The present invention has been made in view of the problems of the above conventional technology, and an object of the present invention is to provide an optical element for an optical pickup apparatus, the optical pickup apparatus employing it and a method of assembling the optical pickup apparatus in which two objective lens sections are made in one body in order to conduct recording and/or reproducing information compatibly properly for different kinds of optical information recording medium.

### Means for Solving the Problem

In this specification, an optical disk (also referred to as an optical information recording medium) using a blue-violet semiconductor laser or a blue-violet SHG laser as a light source for recording and/or reproducing information is called collectively a “high-density optical disk”. The high density optical disk includes an optical disk (for example HD DVD, also merely referred to as HD) standardized such that information recording and/or reproducing are conducted with an objective optical system having a NA of 0.65 to 0.67 and the thickness of a protective layer is about 0.6 mm, in addition to an optical disk (for example BD, blue ray disk) standardized such that information recording and/or reproducing are conducted with an objective optical system having a NA of 0.85 and the thickness of a protective layer is about 0.1 mm. Further, in addition to the optical disks having the above protective layers on their information recording surfaces, the high density optical disk includes an optical having a protective substrate with a thickness of about several to several tens nm on an information recording surface and an optical disk having a protective layer or a protective substrate with a thickness of 0.

Further, in this specification, the high density optical disk includes a magneto-optic disk using a blue-violet semiconductor laser or a blue-violet SHG laser as a light source for recording and/or reproducing information.

In this specification, the term “DVD” is a collective term of DVD series optical disks, such as DVD-ROM, DVD-Video, DVD-Audio, DVD-RAM, DVD-R, DVD-RW, DVD+R, and DVD+RW, and the term “CD” is a collective term of CD series optical disks, such as CD-ROM, CD-Audio, CD-Video, CD-R, and CD-RW. The high density optical disk has the highest recording density, and the recording density becomes lower in DVD and CD in this order.

An optical element for use in an optical pickup apparatus described in claim 1 is an optical element for use in an optical pickup apparatus in which a first objective lens section and a second objective lens section are formed in one body, and is characterized in that one of the first objective lens section and the second objective lens section satisfies the following conditional formula (1) and another one satisfies the following conditional formula (2).

|HCM|/|TCM|<0.3 (1)

|HCM|/|TCM|>0.3 (2)

Here, HCM represents a view angle third order coma sensibility in the first objective lens section or the second objective lens section, and TCM represents a tilt angle third order coma sensibility in the first objective lens section or the second objective lens section.

FIGS. 2(a) and 2(b) each is a schematic diagram showing a system constituted by a light source LD, an objective lens OBJ and an optical disk OD. Fundamentally, as shown by the relationship between a light source LD illustrated with a dotted line and an objective lens OBJ illustrated with a solid line in FIG. 2 (a), or between a light source LD illustrated with a solid line and an objective lens OBJ illustrated with a dotted line in FIG. 2 (b), an arrangement (ideal arrangement) is preferably made such that a normal line of an optical disk coincides with an axis of an objective lens and an light source LD is located on a straight line L including the normal line and the optical axis. Against the above ideal arrangement, if a light source LD is shifted in a direction perpendicular to the optical axis from the straight line L as shown in FIG. 2(a), a third order coma aberration occurs on a spot A formed on an information recording surface of an optical disk OD. On the other hand, against the above ideal arrangement, if an objective lens is tilted by an angle of θ to the straight line L as shown in FIG. 2(b), a third order coma aberration occurs on a spot B formed on an information recording surface of an optical disk OD.

Here, in the case that an objective lens satisfies the conditional formula (1), the third order coma aberration hardly depends on an incident angle of the objective lens caused by the shift of the light source and maintains a small value, however, the dependency over the tilt angle of the objective lens becomes larger. On the other hand, in the case that the objective lens satisfies the conditional formula (2), in comparison with the case of satisfying the conditional formula (1), an amount of the third order coma aberration caused by the tilt angle of the lens are reduced, however, the dependency over the incident angle of the objective lens becomes high.

Therefore, in the case of satisfying the conditional formula (2), when a third order coma aberration occurs on a spot B formed on an information recording surface of an optical disk OD, an amount of the third order coma aberrations to a tilt angle is suppressed relatively small by correcting the tilt angle of an objective lens OB to be flat as shown in FIG. 2(b). However, in the case that the light source LD shifts to a direction perpendicular to the optical axis from the straight line L as shown in FIG. 2 (a), when a third order coma aberration occurs on a spot A formed on an information recording surface of an optical disk OD, there is such a characteristic that an amount of the third order coma aberration to the shift amount becomes relatively large.

Now, explaining more concretely with reference to FIG. 1, if an first objective lens section OBJ1 of an optical element OE is adapted so as to satisfy the conditional formula (1), the optical element OE has such a characteristics that from a viewpoint of a coma aberration, an allowable range for a shift of a light source becomes relatively wide, however, an allowable range for a tilt becomes relatively narrow. Then, as shown in FIG. 1 (b), a tilt adjustment of the first objective lens section OBJ1 is performed in such a way that the entire body of an optical element OE is tilted, whereby recording and/or reproducing information is made to conduct for an information recording surface of a first optical disk OD1. On the other hand, if a second objective lens section OBJ2 is adapted so as to satisfy the conditional formula (2), the optical element OE has such a characteristics that from a viewpoint of a coma aberration, an allowable range for a shift of a light source becomes relatively narrow, however, an allowable range for a tilt becomes relatively wide.

Here, if the entire body of an optical element OE is tilted to the first optical disk OD1 at the time of assembling an optical pickup apparatus in order to reduce a coma aberration of a converged spot by the first objective lens section OBJ1, the second objective lens section OBJ2 is tilted similarly (refer to FIG. 1 (c)). However, on this tilted condition, since the second objective lens section OBJ2 has a relatively wide allowable range for a tilt, a coma aberration can be suppressed to small. On the other hand, in order to reduce a coma aberration on a converged spot by the second objective lens section OBJ2 for the second optical disk OD2, a light source is to be shifted. AT this time, even in the case that light sources corresponding to the first and second optical disks are made in common or a two wavelength one package laser, the first objective lens section OBJ1 has a relatively wide allowable range for a shift of a light source, a third order coma aberration can be suppressed to small. Accordingly, at the time of using the first optical disk OD1, recording and/or reproducing information can be appropriately performed. Therefore, since it is not necessary to correct a tilt for each of used optical disks, it is enough to provide a small actuator. As a result, it is possible to provide an optical pickup apparatus excellent in energy saving with a compact size. Here, in the example of this explanation, the explanation is made such that an objective lens section corresponding to an optical information recording medium with a transparent base plate having a thin thickness satisfies the conditional formula (1). However, the present invention is not limited to the above explanation.

In addition, in a system having a lens and an optical information recording medium with a transparent substrate, “view angle third order coma sensibility” changes in the case that only an incident light flux is inclined by an angle of 1° to a lens without changing a relative tilt between an optical information recording medium and a lens, and “view angle third order coma sensibility” is a value of WFEλ rms of a third order coma aberration on a spot formed on an information recording surface of an optical information recording medium by a light flux having passed through a transparent substrate. In a system having a lens and an optical information recording medium with a transparent substrate, “tilt angle third order coma sensibility” changes in the case that only a lens is inclined by an angle of 1° without changing an tilt between an optical information recording medium and a light flux, and “tilt angle third order coma sensibility” is a value of WFEk rms of a third order coma aberration on a spot formed on an information recording surface of an optical information recording medium by a light flux having passed through a transparent substrate.

Further, “optical element in which formed a first objective lens section and a second objective lens section are formed in one body” is not only an optical element in which a first objective lens section and a second objective lens section are united by being melted (for example, an optical element including a first objective lens section and a second objective lens section are produced by an injection molding process), but also an optical element in which an optical element including a first objective lens section and an optical element including a second objective lens section are produced separately and thereafter these optical elements are united by an engaging process.

Moreover, in the first and second objective lens sections, one objective lens section may correspond to only one kind of optical information recording media as an exclusive lens, and one objective lens section may correspond plural kinds of optical information recording media employing plural light fluxes with different wavelengths as a compatible lens. For example, in the case that an objective lens section is an exclusive lens, an optical surface of the objective lens section may be only a refractive surface. On the other hand, in the case that an objective lens section is a compatible lens, an optical surface of the objective lens section may include an optical path difference providing structures, such as a diffractive mechanism for compatibility. Here, in the case that an objective lens section is a compatible lens, the objective lens section may be adapted to satisfy the conditional formula of the present invention at the time of being used for at least one information recording medium. Further, in the case that an objective lens section is a compatible lens, the objective lens section may be preferably adapted to satisfy the conditional formula of the present invention at the time of being used for an information recording medium employing the shortest wavelength among optical information recording media corresponded by the objective lens section. Further, in addition to the first objective lens section and the second objective lens section, the optical element may comprises a third objective lens section and a fourth objective lens section. For example, in the case that an optical element is formed in one body by a first objective lens section, a second objective lens section and a third objective lens section, an operation mode may be considered such that the a first objective lens section performs recording and/or reproducing information for a first optical information recording medium, the a second objective lens section performs recording and/or reproducing information for a second optical information recording medium, and the third objective lens section performs recording and/or reproducing information for a third optical information recording medium and a fourth optical information recording medium.

The optical element for use in an optical pickup apparatuses described in claim 2 is characterized in the invention described in claim 1 such that the optical pickup apparatus is an optical pickup apparatus which comprises a single light source or plural light sources and the above-mentioned optical element, and converges a light flux from the above light source through the first objective lens section onto an information recording surface of a first information recording medium with a protective substrate having a thickness t1 to enable recording and/or reproducing information for the information recording surface or converges a light flux from the above light source through the second objective lens section onto an information recording surface of a second information recording medium with a protective substrate having a thickness t2 (t2≧t1) to enable recording and/or reproducing information for the information recording surface. According to the present invention, recording and/or reproducing information can be performed to at least two different kinds of optical information recording media.

The optical element for use in an optical pickup apparatuses described in claim 3 is characterized in the invention described in claim 2 such that the first objective lens section satisfies the above-mentioned conditional formula (1) and the second objective lens section satisfies the above-mentioned conditional formula (2).

For example, at the time of an actual operation (at the time of recording or reproducing an optical disk), for optical disks (for example, BD, HD, DVD for recording, and the like) required to correct a third order coma aberration due to an tilt of an optical disk, if the first objective lens section satisfying the conditional formula (1) is used, the third order coma aberration can be corrected at the time of an actual operation by an actuator with an objective optical element tilting function having already put in practical use. Here, instead of tilting an optical element, the coma aberration may be corrected by a coma aberration correcting section, such as a crystal liquid and the like. Further, a technique to tilt an optical element and a coma aberration correcting section, such as a crystal liquid and the like may be used in combination. On the other hand, for optical disks not required to correct a third order coma aberration due to an tilt of an optical disk at the time of an actual operation, the second objective lens section satisfying the conditional formula (2) may be used. At this time, a coma aberration can be corrected by shifting a light source at the time of assembling an optical pickup apparatus. That is, when one objective lens section is used, in the case that a third order coma aberration caused by an tilt of an optical disk is corrected at the time of an actual operation by a mechanism to tilt an optical element or a coma aberration correcting element such as a liquid crystal, it is desirable to satisfy the above-mentioned conditional formula. Here, generally, an optical disk with a large recording density has a high necessity to form a good spot, therefore it is more necessary to correct a third order coma aberration at the time of an actual operation. For example, in the case that the first objective lens section performs recording and/or reproducing for BD and the second objective lens section performs recording and/or reproducing for DVD and CD, since it is desirable to correct a third order coma aberration by the first objective lens section at the time of an actual operation, it is desirable that the first objective lens section satisfies the conditional formula (1) and the second objective lens section satisfies the conditional formula (2). Further, also in the case that the first objective lens section performs recording and/or reproducing for HD and the second objective lens section performs recording and/or reproducing for DVD and CD, since it is desirable to correct a third order coma aberration by the first objective lens section at the time of an actual operation, it is desirable that the first objective lens section satisfies the conditional formula (1) and the second objective lens section satisfies the conditional formula (2). Moreover, in the case that the first objective lens section performs recording and/or reproducing for BD and HD and the second objective lens section performs recording and/or reproducing for DVD and CD, since it is desirable to correct a third order coma aberration by the first objective lens section at the time of an actual operation, it is desirable that the first objective lens section satisfies the conditional formula (1) and the second objective lens section satisfies the conditional formula (2).

The optical element for use in an optical pickup apparatuses described in claim 4 is characterized in the invention described in claim 2 such that the first objective lens section satisfies an above-mentioned conditional formula (2) and the second objective lens section satisfies an above-mentioned conditional formula (1).

For example, for a specification in which the degree of an amount of a third order coma aberration generated by the tilt of an objective lens section is large (NA is large, a transparent substrate is thicker, and the like), namely, for an optical disk having a large tilt sensibility, if an objective lens satisfying the conditional formula (2) is used, since an amount of a third order coma aberration generated by the tilt of an optical element (an objective lens section) is made small. Therefore, since an accuracy required for an attitude (tile) of an optical element at the time of operating an actuator is eased, a fabrication of the actuator becomes easy. Further, at the time of assembling an optical pickup apparatus, a third order coma aberration can be corrected by shifting a light source. In this case, in the case of correcting a third order coma aberration due to the tilt of an optical disk at the time of an actual operation, it is possible to conduct the correction by tilting the entire body of an optical pickup apparatus. Moreover, by the structure that another objective lens section satisfies the conditional formula (1), it becomes possible to correct a third order coma aberration without tilting an optical element greatly at the time of assembling an optical pickup apparatus.

In addition, in the case that one of objective lens sections is used to perform recording and/or reproducing for BD and by and another one of objective lens sections is used to perform recording and/or reproducing for HD, it is especially desirable to satisfy the present condition. As compared with BD, HD is required more to correct a third order coma aberration due to the tilt of an optical disk at the time of an actual operation. Moreover, with the consideration to conduct correcting a third order coma aberration in an optical pickup apparatus at the time of an actual operation, in order to attain to make an optical pickup apparatus in a smaller size and a thinner shape, it is desirable to correct a third order coma aberration by tilting an optical element (further, an optical element holding section of an actuator, and the like). In this case, in order to correct efficiently, it is desirable to enable to correct a third order coma aberration without tilting an optical element greatly. Therefore, it is desirable that an objective lens section used for recording and/or reproducing HD satisfies the conditional formula (1). Further, if an objective lens section corresponding to HD satisfies the conditional formula (1), it is desirable, because an adjustment at the time of assembling an optical pickup apparatus can be conducted by tilting it by a small angle. Here, instead of tilting an optical element, the coma aberration may be corrected by a coma aberration correcting section, such as a liquid crystal. Furthermore, the technique to tilt an optical element and the coma aberration correcting section such as a liquid crystal may be used in combination.

The optical element for use in an optical pickup apparatuses described in claim 5 is characterized in the invention described in any one of claims 2 to 4 such that the above-mentioned light source is a first light source to emit a first light flux with a wavelength of λ1, the first light flux is converged onto an information recording surface of a first optical information recording medium through the first objective lens section, and the first light flux is converged onto an information recording surface of a second optical information recording medium through the second objective lens section.

For example, in the above-mentioned example of BD and HD, since BD and HD employ a light flux with the same wavelength, the possibility to use a common light source is high. In this case, with regard to a correcting technique to correct a third order coma aberration at the time of assembling an optical pickup apparatus, the correcting technique is conducted by correcting a tilt of an optical element for an objective lens section (for example, an objective lens section for HD) satisfying the conditional formula (1), and, on other hand, the correcting technique is conducted by adjusting a shift of a light source for an objective lens section (for example, an objective lens section for BD) satisfying the conditional formula (2). Here, in this example, if the shift adjustment of a light source is conducted for the objective lens section corresponding to BD, the objective lens section corresponding to HD is influenced by the shift of the light source. However, since the objective lens section corresponding to HD has a large tolerance for the shift of the light source, even if the shift adjustment of a light source is conducted, the adjustment does not influence greatly recording and/or reproducing HD. If necessary, after conducting the shift adjustment of a light source, the adjustment for HD may be conducted again by adjusting the tilting angle of an optical element. If these adjustments are repeatedly conducted, the adjustment accuracy can be enhanced more. Here, it is desirable that the wavelength λ1 is 350 nm or more and 440 nm or less.

The optical element for use in an optical pickup apparatuses described in claim 6 is characterized in the invention described in claim 5 such that the following formulas (3) and (4) are satisfied.

0.03≦t1(mm)≦0.14 (3)

0.5≦t2(mm)≦0.8 (4)

The first optical information recording medium and the second optical information recording medium may have plural recording layers, and may have a single recording layer. Especially, when the first optical information recording medium is constituted by a single recording layer, it is desirable that the substrate thickness t1 is 0.07 mm or more and 0.1125 mm or less. Further, the first optical information recording medium is BD and comprises plural recording layers, it is desirable that the first optical information recording medium comprises plural recording layer of four layers, six layers, eight layers, or ten layers. Here, in the case that BD being the first optical information recording medium comprises the plural recording layer of four layers, six layers, or eight layers, it is desirable that the value of t1 is 0.03 mm or more and 0.13 mm or less. Further, in the case that the second optical information recording medium is HD and comprises plural recording layers, it is desirable that he second optical information recording medium comprises the plural recording layers of three layers. For example, an embodiment is exemplified such that the first objective lens section corresponds to BD and the second objective lens section corresponds to HD. At this time, the second objective lens section may be an exclusive lens corresponding to only HD, or may be a compatible lens corresponding to DVD and/or CD in addition to HD.

The optical element for use in an optical pickup apparatuses described in claim 7 is characterized in the invention described in any one of claims 1 to 6 such that the first objective lens section and the second objective lens section are integrally formed so that the above-mentioned optical element is formed in one body. For example, the embodiment of this term is exemplified with the case where the optical element comprising the first objective lens section and the second objective lens section is obtained by an injection molding.

The optical element for use in an optical pickup apparatuses described in claim 8 is characterized in the invention described in any one of claims 1 to 6 such that the first objective lens section and the second objective lens section are engaged so that the above-mentioned optical element is formed in one body. For example, the embodiment of this term is exemplified with the case where an optical element including the first objective lens section and an optical element including the second objective lens section are produced separately, and thereafter the first objective lens section and the second objective lens section are fit to each other into one body as the above-mentioned optical element.

The optical element for use in an optical pickup apparatuses described in claim 9 is characterized in the invention described in any one of claims 1 to 8 such that an angle formed between the direction of the third order coma aberration of the first objective lens section and the direction of the third order coma aberration of the second objective lens section is 30 degrees or less.

It is preferable that the direction of the third order coma aberration of the first objective lens section is matched with the direction of the third order coma aberration of the second objective lens section. Because, at the time of correcting a third order coma aberration by tilting the first objective lens section, the third order coma aberration on the first objective lens section is corrected to some extent in connection with the above correction.

Further, in this case, it is especially desirable that the objective lens section satisfying the conditional formula (2) satisfies the following conditional formula (2′).

0.6>|HCM|/|TCM|>0.3 (2′)

Here, the direction of a third order coma aberration will be explained. FIG. 16 (a) is a diagram in which the optical element OE comprising the first objective lens section OBJ1 and the second objective lens section OBJ2 is viewed from a converged spot side. On this plan view, here, a straight line passing on the optical axis L1 of the first objective lens section OBJ1 and the optical axis L2 of the second objective lens section OBJ2 is made as an X axis, the direction passing through the optical axis L1 and intersecting perpendicularly with the X axis is made as a Y1 axis, the direction passing through the optical axis L2 and intersecting perpendicularly with the X axis is made as a Y2 axis. FIGS. 16(b) and 16(c) each is a diagram showing a spot image converged by the first objective lens section OBJ1 and the second objective lens section OBJ2 shown in FIG. 16 (a), and coordinate axes in these diagrams are determined in the same way in FIG. 16 (a).

In the case that the first objective lens section OBJ1 and the second objective lens section OBJ2 have a third order coma aberration, as shown in FIGS. 16(b) and 16(c), a variation or deflection is caused in intensity in the respective first order diffraction rings DR1 and DR2 formed around the periphery of the converged spot SP1 and SP2. The direction of this deflection in the first order diffraction rings DR1 and DR2 (the direction toward from the optical axis to the center of the first order diffraction ring) is made as the direction of a third order coma aberration. Here, a right-handed rotation is made positive on the basis of the direction of the Y1 axis and the Y2 axis. Therefore, in the example in FIG. 16(b), the direction of a third order coma aberration is the direction at 0° in both of the first objective lens section OBJ1 and the second objective lens section OBJ2. In the example of FIG. 16 (c), the direction of a third order coma aberration of the first objective lens section OBJ1 is the direction at 135°, and the direction of a third order coma aberration of the second objective lens section OBJ2 is the direction at 270°.

Here, the first objective lens section OBJ1 or the second objective lens section OBJ2 is used for recording and/or reproducing information for plural kinds of optical disks (a so-called compatible objective lens), and in the case that a light flux with a different wavelength is used depending on the kind of an optical disk at the time of recording and/or reproducing information, the direction of a third order coma aberration to a light flux with the shortest wavelength is defined as “the direction of a third order coma aberration” in the concerned objective lens section, unless specified specifically.

The optical element for use in an optical pickup apparatuses described in claim 10 is characterized in the invention described in any one of claims 2 to 6 such that the optical pickup apparatus converges a light flux onto an information recording surface of a third optical information recording medium with a protective substrate having a thickness of t3 (t2≦t3) so as to conduct recording and/or reproducing information for the information recording surface, the above-mentioned light source has a first light source to emit a first light flux with a wave length of λ1 and a second light source to emit a second light flux with a wave length of λ2 (λ2>λ1), the first light flux is converged onto an information recording surface of the first optical information recording medium through the first objective lens section, the first light flux is converged onto an information recording surface of the second optical information recording medium through the second objective lens section, and the second light flux is converged onto an information recording surface of the third optical information recording medium through the second objective lens section.

According to the present invention, recording and/or reproducing information can be performed for at least three kinds of different optical information recording media. Here, it is desirable that t3 is 0.5 mm or more and 0.8 mm or less. Also, it is desirable that λ2 is 600 nm or more and 700 nm or less.

The optical element for use in an optical pickup apparatus described in claim 11 is characterized in the invention described in claim 10 such that the optical pickup apparatus converges a light flux onto an information recording surface of a fourth optical information recording medium with a protective substrate having a thickness of t4 (t4>t3) so as to conduct recording and/or reproducing information for the information recording surface, the above-mentioned light source has a first light source to emit a first light flux with a wave length of λ1, a second light source to emit a second light flux with a wave length of λ2 (λ2>λ1) and a third light source to emit a third light flux with a wave length of λ3 (λ3>λ2), the first light flux is converged onto an information recording surface of the first optical information recording medium through the first objective lens section, the first light flux is converged onto an information recording surface of the second optical information recording medium through the second objective lens section, the second light flux is converged onto an information recording surface of the third optical information recording medium through the second objective lens section, and the third light flux is converged onto an information recording surface of the fourth optical information recording medium through the second objective lens section.

According to the present invention, recording and/or reproducing information can be performed for at least four kinds of different optical information recording media. Here, a desirable example of the first optical disk is BD, a desirable example of the second optical disk is HD, a desirable example of the third optical disk is DVD and a desirable example of the fourth optical disk is CD. Here, it is desirable that t4 is 1.0 mm or more and 1.3 mm or less. Also, it is desirable that λ3 is 700 nm or more and 800 nm or less.

Here, a combination of an optical information and an objective lens section applicable with the optical element of the present invention is not restricted to the above-mentioned examples. The optical element of the present invention can be applied also to the following embodiments. For example, the optical pickup apparatus converges a light flux onto an information recording surface of a third optical information recording medium with a protective substrate having a thickness of t3 (t2≦t3) so as to conduct recording and/or reproducing information for the information recording surface, and converges a light flux onto an information recording surface of a fourth optical information recording medium with a protective substrate having a thickness of t4 (t4>t3) so as to conduct recording and/or reproducing information for the information recording surface; the above-mentioned light source has a first light source to emit a first light flux with a wave length of λ1, a second light source to emit a second light flux with a wave length of λ2 (λ2>λ1) and a third light source to emit a third light flux with a wave length of λ3 (λ3>λ2); the first light flux is converged onto an information recording surface of the first optical information recording medium through the first objective lens section, the first light flux is converged onto an information recording surface of the second optical information recording medium through the first objective lens section, the second light flux is converged onto an information recording surface of the third optical information recording medium through the second objective lens section, and the third light flux is converged onto an information recording surface of the fourth optical information recording medium through the second objective lens section.

Here, a desirable example of the first optical disk is BD, a desirable example of the second optical disk is HD, a desirable example of the third optical disk is DVD and a desirable example of the fourth optical disk is CD.

The optical element for use in an optical pickup apparatuses described in claim 12 is characterized in the invention described in any one of claims 1 to 9 such that at least one of the first objective lens section and the second objective lens section comprises a ring-shaped optical path difference providing structure.

As the ring-shaped optical path difference providing structure, a ring-shaped diffractive structure and a structure divided into exclusive regions for a certain optical information recording medium may be listed. The optical path difference providing structure may be used to conduct a correction for a change of a spherical aberration generated at the time that temperature or humidity changes, and a correction for a change of a spherical aberration generated at the time that wavelength changes. Also, the optical path difference providing structure may be used to conduct to correct a difference in spherical aberration generated at the time of recording and/or reproducing plural information recording media different in thickness of a transparent substrate or necessary NA (numerical aperture) by utilizing a difference in wavelength of used light fluxes in such a way that recording and/or reproducing can be conducted for plural optical information medium with a single objective lens section, or also a light flux having passed through a certain region is converged onto an information recording surface of a certain optical information recording medium and a light flux having passed through other region is converged onto an information recording surface of other optical information recording medium.

An optical pickup apparatus described in claim 13 is characterized in that the optical pickup apparatus comprises a single or plural light sources and an optical element in which a first objective lens section and a second objective lens section are made in one body, the optical pickup apparatus converges a light flux from the light source through the first objective lens section onto an information recording surface of a first optical information recording medium with a protective substrate having a thickness of t1 so as to conduct recording and/or reproducing information for the information recording surface, and converges a light flux from the light source through the second objective lens section onto an information recording surface of a second optical information recording medium with a protective substrate having a thickness of t2 (t2≧t1) so as to conduct recording and/or reproducing information for the information recording surface, the optical pickup apparatus further comprises a relative tilt changing section to change a relative tilt between the optical element and the first optical information recording medium or the second optical information recording medium, and one of the first objective lens section and the second objective lens section satisfies the following conditional formula (1) and another one satisfies the following conditional formula (2).

|HCM|/|TCM|>0.3 (1)

|HCM|/|TCM|<0.3 (2)

Here, HCM represents a view angle third order coma sensibility in the first objective lens section or the second objective lens section, and TCM represents a tilt angle third order coma sensibility in the first objective lens section or the second objective lens section.

The operation and effect of this invention is the same as those in the invention in claim 1 and clam 2.

The optical pickup apparatuses described in claim 14 is characterized in the invention described in claim 13 such that the first objective lens section satisfies the above-mentioned conditional formula (1) and the second objective lens section satisfies the above-mentioned conditional formula (2).

The operation and effect of this invention is the same as those in the invention in claim 3.

The optical pickup apparatuses described in claim 15 is characterized in the invention described in claim 13 such that the first objective lens section satisfies an above-mentioned conditional formula (2) and the second objective lens section satisfies an above-mentioned conditional formula (1).

The operation and effect of this invention is the same as those in the invention in claim 4.

The optical pickup apparatuses described in claim 16 is characterized in the invention described in any one of claims 13 to 15 such that the above-mentioned light source is a first light source to emit a first light flux with a wavelength of λ1, the first light flux is converged onto an information recording surface of a first optical information recording medium through the first objective lens section, and the first light flux is converged onto an information recording surface of a second optical information recording medium through the second objective lens section.

The operation and effect of this invention is the same as those in the invention in claim 5.

The optical pickup apparatuses described in claim 17 is characterized in the invention described in claim 16 such that the following formulas (3) and (4) are satisfied.

0.03≦t1(mm)≦0.14 (3)

0.5≦t2(mm)≦0.8 (4)

The operation and effect of this invention is the same as those in the invention in claim 6.

The optical pickup apparatuses described in claim 18 is characterized in the invention described in any one of claims 13 to 17 such that the first objective lens section and the second objective lens are integrally formed so that the above-mentioned optical element is formed in one body.

The operation and effect of this invention is the same as those in the invention in claim 7.

The optical pickup apparatuses described in claim 19 is characterized in the invention described in any one of claims 13 to 17 such that the first objective lens section and the second objective lens are engaged so that the above-mentioned optical element is formed in one body.

The operation and effect of this invention is the same as those in the invention in claim 8.

The optical pickup apparatuses described in claim 20 is characterized in the invention described in any one of claims 13 to 19 such that an angle formed between the direction of the third order coma aberration of the first objective lens section and the direction of the third order coma aberration of the second objective lens section is 30 degrees or less.

The operation and effect of this invention is the same as those in the invention in claim 9.

The optical pickup apparatuses described in claim 21 is characterized in the invention described in any one of claims 13 to 20 such that the optical pickup apparatus converges a light flux onto an information recording surface of a third optical information recording medium with a protective substrate having a thickness of t3 (t2≦t3) so as to conduct recording and/or reproducing information for the information recording surface, the above-mentioned light source has a first light source to emit a first light flux with a wave length of λ1 and a second light source to emit a second light flux with a wave length of λ2 (λ2>λ1), the first light flux is converged onto an information recording surface of the first optical information recording medium through the first objective lens section, the first light flux is converged onto an information recording surface of the second optical information recording medium through the second objective lens section, and the second light flux is converged onto an information recording surface of the third optical information recording medium through the second objective lens section.

The operation and effect of this invention is the same as those in the invention in claim 10.

The optical pickup apparatus described in claim 22 is characterized in the invention described in claim 21 such that the optical pickup apparatus converges a light flux onto an information recording surface of a fourth optical information recording medium with a protective substrate having a thickness of t4 (t4>t3) so as to conduct recording and/or reproducing information for the information recording surface, the above-mentioned light source has a first light source to emit a first light flux with a wave length of λ1, a second light source to emit a second light flux with a wave length of λ2 (λ2>λ1) and a third light source to emit a third light flux with a wave length of λ3 (λ3>λ2), the first light flux is converged onto an information recording surface of the first optical information recording medium through the first objective lens section, the first light flux is converged onto an information recording surface of the second optical information recording medium through the second objective lens section, the second light flux is converged onto an information recording surface of the third optical information recording medium through the second objective lens section, and the third light flux is converged onto an information recording surface of the fourth optical information recording medium through the second objective lens section.

The operation and effect of this invention is the same as those in the invention in claim 11.

The optical pickup apparatuses described in claim 23 is characterized in the invention described in any one of claims 13 to 22 such that at least one of the first objective lens section and the second objective lens section comprises a ring-shaped optical path difference providing structure.

The operation and effect of this invention is the same as those in the invention in claim 12.

An assembling method of an optical pickup apparatus described in claim 24 is an assembling method of an optical pickup apparatus which comprises a single or plural light sources and an optical element in which a first objective lens section and a second objective lens section are made in one body, wherein the optical pickup apparatus converges a light flux from the light source through the first objective lens section onto an information recording surface of a first optical information recording medium with a protective substrate having a thickness of t1 so as to conduct recording and/or reproducing information for the information recording surface, and converges a light flux from the light source through the second objective lens section onto an information recording surface of a second optical information recording medium with a protective substrate having a thickness of t2 (t2≧t1) so as to conduct recording and/or reproducing information for the information recording surface, and one of the first objective lens section and the second objective lens section satisfies the following conditional formula (1) and another one satisfies the following conditional formula (2), the assembling method of an optical pickup apparatus is characterized in that the assembling method comprises:

a step of adjusting an tilt of the optical element so as to reduce a coma aberration of a converged light spot when a light flux from the light source is converged onto an information recording surface of the first information recording medium through the objective lens section satisfying the conditional formula (1) among the first objective lens section and the second objective lens section; and

a step of conducting a shift adjusting process for the light source so as to reduce a coma aberration of a converged light spot when a light flux from the light source is converged onto an information recording surface of the second information recording medium through the objective lens section satisfying the conditional formula (2) among the first objective lens section and the second objective lens section,

|HCM|/|TCM|<0.3 (1)

|HCM|/|TCM|>0.3 (2)

wherein HCM represents a view angle third order coma sensibility in the first objective lens section or the second objective lens section, and TCM represents a tilt angle third order coma sensibility in the first objective lens section or the second objective lens section.

Here, comments are added such that what is described in the above assembling method is the adjustments at the time of assembling an optical pickup apparatus and is not a control at the time of an actual use when information is actually recorded into or reproduced from an optical information recording medium after the optical pickup apparatus was assembled.

With regard to the term “objective lens section” in the present specification, in a narrow sense, on the condition that an optical information recording medium is loaded on an optical pickup apparatus, the objective lens section is designated as a lens section which is arranged at a side closest to the optical information recording medium so as to oppose it and has a light converging action, and in a broad sense, the objective lens section is designated as a lens section which can be actuated at least in its optical axis direction together with an optical element by an actuator.

### EFFECT OF THE INVENTION

According to the present invention, in order to conduct recording and/or reproducing information compatibly for different optical disks, it is possible to provide an optical element constituted integrally by two objective lens sections for use in an optical pickup apparatus and to provide an optical pickup apparatus employing the optical element.

### BRIEF DESCRIPTION OF THE DRAWING

FIG. 1 is an illustration for explaining problems in conventional technologies.

FIG. 2 is a schematic diagram showing a system constituted by a light source LD, an objective lens section OBJ and an optical disk OD.

FIG. 3 is an outline cross sectional view of an optical pickup apparatus according to the third embodiment.

FIG. 4 is a cross sectional view of a lens holder holding two objective lens sections.

FIG. 5 is a perspective view of an tilt changing mechanism 10 to adjust an tilt of an objective lens with an entire body of an optical pickup apparatus.

FIG. 6 is a perspective view of an tilt changing mechanism 20 to adjust an tilt of an objective lens with an entire body of a lens holder.

FIG. 7 is a perspective view of an tilt changing mechanism 30 to adjust an tilt of an objective lens with an entire body of an optical pickup apparatus.

FIG. 8 is an outline cross sectional view of an optical pickup apparatus according to the fourth embodiment.

FIG. 9 is an outline cross sectional view of an optical pickup apparatus according to the fifth embodiment.

FIG. 10 is an outline cross sectional view of an optical pickup apparatus according to the sixth embodiment.

FIG. 11 is an outline cross sectional view of an optical pickup apparatus according to the seventh embodiment.

FIG. 12 is a cross sectional view showing two examples holding a light source of a two laser one package type and a diffractive element.

FIG. 13 is a cross sectional view showing a modified example of a lens holder as being similar to FIG. 3.

FIG. 14 is a view looking one example of an optical pickup apparatus from the top face.

FIG. 15 is an outline cross sectional view of an optical pickup apparatus according to the first embodiment.

FIG. 16 (a) is a view looking an objective lens unit OLU comprising a first objective lens section OBJ1 and a second objective lens section OBJ2 from a converged light spot side.

FIG. 16(b) and FIG. 16 (c) each is a diagram showing spot images converged by the first objective lens section OBJ1 and the second objective lens section OBJ2 shown in FIG. 16 (a).

FIG. 17 is an outline cross sectional view of an optical pickup apparatus according to the second embodiment.

FIG. 18 is an outline cross sectional view showing a modified example of FIG. 15.

FIG. 19 is an illustration showing an angle difference of a lens holder HD supporting an objective lens section.

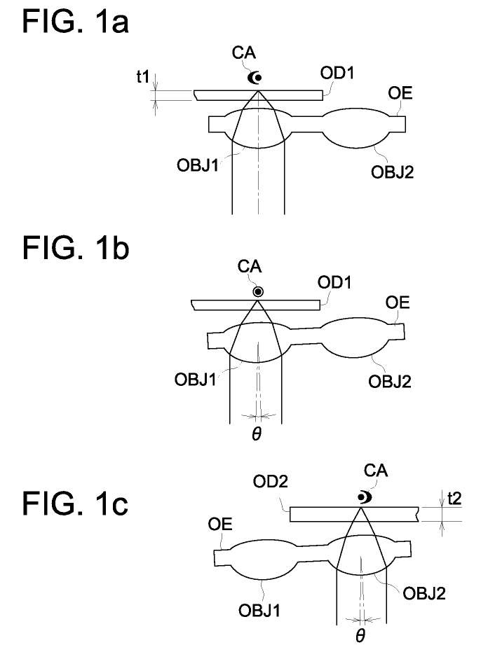

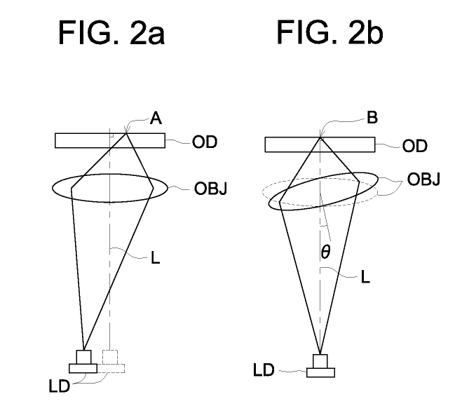

### EXPLANATION OF SYMBOL

LD1 First semiconductor laser
LD2 Second semiconductor laser
LD3 Third semiconductor laser
HD Lens holder
OBJ1 First objective lens section
OBJ2 Second objective lens
OE Optical element
ACT Actuator
ACTB Actuator base
10, 20, and 30 Tilt changing mechanism

### BEST MODE FOR CARRING OUT THE INVENTION

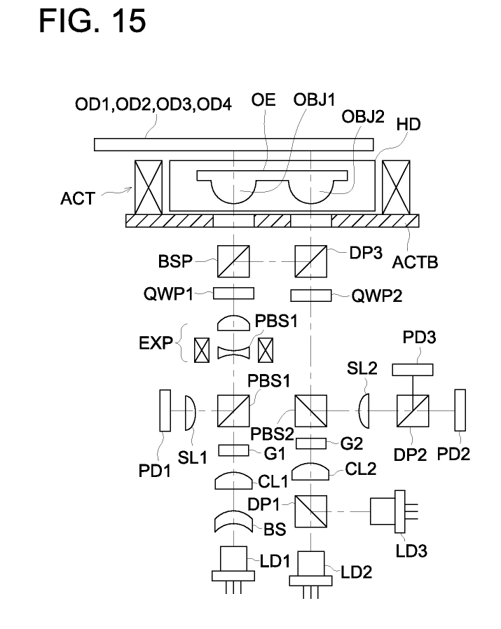

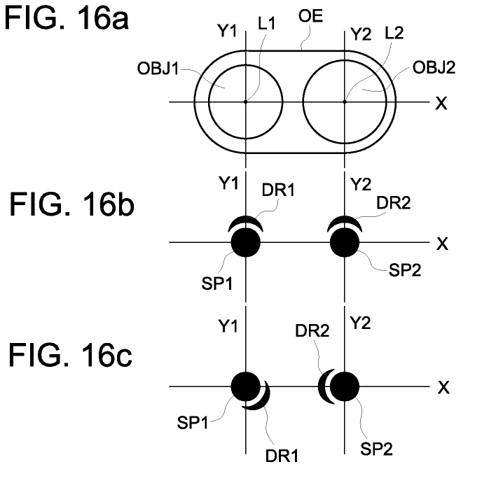

Hereafter, the present invention will be explained more in detail with reference to drawings. FIG. 15 is an outline cross sectional view of an optical pickup apparatus according to the first embodiment in which recording and/or reproducing information can be conducted to all a BD (also referred to as a first optical information recording medium or a first optical disk), a HD (also referred to as a second optical information recording medium or a second optical disk), a DVD (also referred to as a third optical information recording medium or a third optical disk), and a CD (also referred to as a fourth optical information recording medium or a fourth optical disk). FIG. 4 is a cross sectional view of an optical element OE constituted integrally by a technique to unite two objective lens sections and a lens holder HD to hold the optical element OE. Here, the first objective lens section OBJ1 has only a refractive surface, and the second objective lens section OBJ2 is provided with a diffractive structure as an optical path difference providing structure for compatibility. Further, the first objective lens section and/or the second objective lens section may be provided with a diffractive structure as an optical path difference providing structure for correcting a change of a spherical aberration at the time that temperature changes or wavelength slightly changes, whereby their optical characteristic can be improved.

In FIG. 4, the optical element OE is integrally formed in one boy with the first objective lens section OBJ1 and the second objective lens section OBJ2 in such a way that the first objective lens section OBJ1 and the second objective lens section OBJ2 are linked with a plate-shaped flange FL so as to make their optical axes parallel to each other. In the lens holder HD, two openings HDa and HDb are formed such that their axis lines are almost parallel to each other. The upper part common to both of the openings HDa and HDb in the drawing is shaped to form a concave seat section HDc and the flange FL of the optical element OE is mounted to come in contact with the concave seat section HDc. On this condition, the opening HDa is positioned opposite to the first objective lens section OBJ1, and the opening HDb is positioned opposite to the second objective lens section OBJ2. Here, in the opening HDa and the opening HDb, aperture diaphgrams AP1 and AP2 are formed respectively.

In the embodiment shown in FIG. 15, a first semiconductor laser LD1, a second semiconductor laser LD2 and a third semiconductor laser LD3 are arranged independently.

As shown in FIG. 15, the lens holder HD is supported so as to be movable into at least two dimensional directions by an actuator ACT. The actuator ACT comprises an actuator base ACTB attached to a frame (not shown in the drawing) of an optical pickup apparatus so as to make its position adjustable.

In the case that recording and/or reproducing information is conducted for BD (OD1) being a first optical disk, in FIG. 15, a light flux emitted from the first semiconductor laser LD1 (wavelength λ1=350 nm to 440 nm) as a first light source passes through a beam shaper BS with which the shape of the light flux is corrected, and the light flux enters into first collimating lens CL1. The light flux exited from the first collimating lens CL1 passes through a first diffractive grating element G1 being an optical section to divide a light flux emitted from a light source into a main beam used for recording and/or reproducing and a sub beam used for detecting a tracking error signal, and further the light flux passes through a first polarizing beam splitter PBS1 and an expander lens EXP.

The light flux having passed through the expander lens EXP further passes through a first λ/4 wavelength plate QWP1, and a predetermined light amount of the light flux is reflected by a prism BSP, and the remaining light amount of the light flux passes through the prism BSP. The light flux having passed through the prism BSP is converged onto an information recording surface of a BD (OD1) through its protecting layer (thickness t1=0.03 to 0.14 mm) by a first objective lens section OBJ1, and forms a converged light spot on it. Here, at least one optical element of an expander lens EXP is made movable in a direction of its optical axis. Therefore, the optical element is moved in the direction of its optical axis so as to change the degree of divergence of an outgoing light flux from the expander lens EXP, whereby it is possible to correct a spherical aberration of a converged light spot caused by an error of a protective layer thickness of an optical disk or a difference in a protective layer thickness to each recording surface of an optical disk (so-called two layer disc or multilayer disc) having plural layers of information recording surfaces.

And then, the light flux is modulated by information pits on the information recording surface and is reflected on the information recording surface. The reflected light flux passes again through the first objective lens section OBJ1, the prism BSP, the first λ/4 wavelength plate QWP1 and the expander lens EXP. Thereafter, the light flux is reflected by a first polarizing beam splitter PBS1 and enters into a light receiving surface of a first photodetector PD1 through a first sensor lens SL1, whereby recording and/or reproducing information is conducted for the BD (OD1) by output signals from the first photodetector PD1.

Moreover, an in-focus detection and a truck detection are conducted by detecting a change in the shape of a light spot and a change in the light amount due to a positional change on the first photodetector PD1. Based on this detection, an actuator ACT is driven to shift the first objective lens section OBJ1 with the entire body of the lens holder HD in such a way that a light flux from the first semiconductor laser LD1 is formed an image on the information recording surface of the BD (OD1).

In the case that recording and/or reproducing information is conducted for a HD (OD2) being a second optical disk, in FIG. 15, a light flux emitted from the first semiconductor laser LD1 (wavelength λ1=350 nm to 440 nm) as the first light source passes through a beam shaper BS by which the shape of the light flux is corrected. Thereafter, the light flux enters into a first collimating lens CL1. The light flux exited from the first collimating lens CL1 passes through a first diffractive grating element G1 being an optical section to divide a light flux emitted from a light source into a main beam for recording and/or reproducing information and a sub beam for detecting tracking error signals, and the light flux further passes through the first polarizing beam splitter PBS1 and the expander lens EXP.

The light flux having passed through the expander lens EXP further passes through the first λ/4 wavelength plate QWP1, and a predetermined light amount of the light flux is reflected by the prism BSP, and the remaining light amount of the light flux passes through the prism BSP. The light flux having passed through the prism BSP is further reflected by a dichroic prism DP3 which reflects a light flux from a first semiconductor laser LD1 and allows a light flux from a second semiconductor laser LD2 and a light flux from a third semiconductor laser LD3 to pass through. Then, the reflected light flux is converged onto an information recording surface of a HD (OD2) through its protecting layer (thickness t1=0.5 to 0.8 mm) by a second objective lens section OBJ2 having a diffractive structure, and forms a converged light spot on it.

And then, the light flux is modulated by information pits on the information recording surface and is reflected on the information recording surface. The reflected light flux passes again through the second objective lens section OBJ2, reflected by the dichroic prism DP3, further reflected by the prism BSP, and passes through the first λ/4 wavelength plate QWP1 and the expander lens EXP. Thereafter, the light flux is reflected by the first polarizing beam splitter PBS1 and enters into the light receiving surface of the first photodetector PD1 through the first sensor lens SL1, whereby recording and/or reproducing information is conducted for the HD (OD2) by output signals from the first photodetector PD1.

Moreover, an in-focus detection and a truck detection are conducted by detecting a change in the shape of a light spot and a change in the light amount due to a positional change on the first photodetector PD1. Based on this detection, an actuator ACT is driven to shift the second objective lens section OBJ2 with the entire body of the lens-holder HD in such a way that a light flux from the first semiconductor laser LD1 is formed an image on the information recording surface of the HD (OD2).

In the case that recording and/or reproducing information is conducted for a DVD (OD3) being a third optical disk, a light flux emitted from a second semiconductor laser LD2 (wavelength λ2=600 nm to 700 nm) passes through a first dichroic prism DP1 and enters into a second collimating lens CL2. Then, the light flux passes through a second diffractive grating element G2, a second polarizing beam splitter PBS2, a second λ/4 wavelength plate QWP2, and the dichroic prism DP3. Thereafter, the light flux is converged onto an information recording surface of a DVD (OD3) through its protecting layer (thickness t2=0.5 to 0.8 mm) by the second objective lens section OBJ2 having the diffractive structure, and forms a converged light spot on it.

And then, the light flux is modulated by information pits on the information recording surface and is reflected on the information recording surface. The reflected light flux passes again through the second objective lens section OBJ2, the dichroic prism DP3, and the second λ/4 wavelength plate QWP2, reflected by the second polarizing beam splitter PBS2, and enters into a light receiving surface of a second photodetector PD2 through a second sensor lens SL2 and a second dichroic prism DP2, whereby recording and/or reproducing information is conducted for the DVD (OD3) by output signals from the second photodetector PD2.

Moreover, an in-focus detection and a truck detection are conducted by detecting a change in the shape of a light spot and a change in the light amount due to a positional change on the second photodetector PD2. Based on this detection, the actuator ACT is driven to shift the second objective lens section OBJ2 with the entire body of the lens-holder HD in such a way that a light flux from the second semiconductor laser LD2 is formed an image on the information recording surface of the DVD (OD3).

In the case that recording and/or reproducing information is conducted for a CD (OD4) being a fourth optical disk, a light flux emitted from a third semiconductor laser LD3 (wavelength λ3=700 nm to 800 nm) is reflected by a first dichroic prism DP1, and enters into a second collimating lens CL2. Further, the light flux passes through the second diffractive grating element G2, the second polarizing beam splitter PBS2, the second λ/4 wave plate QWP2, and the dichroic prism DP3. Thereafter, the light flux is converged onto an information recording surface of a CD (OD4) through its protecting layer (thickness t3=1.0 to 1.3 mm) by the second objective lens section OBJ2 having the diffractive structure, and forms a converged light spot on it.

And then, the light flux is modulated by information pits on the information recording surface and is reflected on the information recording surface. The reflected light flux passes again through the second objective lens section OBJ2, the dichroic prism DP3, and the second λ/4 wavelength plate QWP2, and is reflected by the second polarizing beam splitter PBS2. Then, the light flux passes through a second sensor lens SL2, is reflected by the second dichroic prism DP2, and enters into a light receiving surface of a third photodetector PD3, whereby recording and/or reproducing information is conducted for the CD (OD4) by output signals from the third photodetector PD3.

Moreover, an in-focus detection and a truck detection are conducted by detecting a change in the shape of a light spot and a change in the light amount due to a positional change on the third photodetector PD3. Based on this detection, the actuator ACT is driven to shift the second objective lens section OBJ2 with the entire body of the lens-holder HD in such a way that a light flux from the third semiconductor laser LD3 is formed an image on the information recording surface of the CD (OD4).

Here, since the second objective lens section OBJ2 comprises an optical path difference providing structure like a diffractive structure, an aberration caused by a difference in thickness among transparent substrates of different optical disks is made to be cancelled by a aberration caused by the diffractive structure due to a difference in wavelength among light fluxes, whereby it makes it possible to record or reproduce different optical disks by a single objective lens section.

A method of assembling an optical element according to this embodiment will be explained.

In the optical element of this embodiment, the first objective lens section OBJ1 is designed to satisfy the conditional formula (2) at the time of conducting recording and/or reproducing the first optical disk (BD) by using a light flux from the first semiconductor laser LD1, and the second objective lens section OBJ2 is designed to satisfy the conditional formula (1) at the time of conducting recording and/or reproducing the second optical disk (HD) by using a light flux from the first semiconductor laser LD1.

|HCM|/|TCM|<0.3 (1)

|HCM|/|TCM|>0.3 (2)

Here, HCM represents a view angle third order coma sensibility in the first objective lens section or the second objective lens section, and TCM represents a tilt angle third order coma sensibility in the first objective lens section or the second objective lens section.

Further, the second objective lens section OBJ2 is designed to satisfy the conditional formula (2) at the time of conducting recording and/or reproducing the third optical disk (DVD) by using a light flux from the second semiconductor laser LD2. Furthermore, the second objective lens section OBJ2 is designed to satisfy the conditional formula (2) at the time of conducting recording and/or reproducing the fourth optical disk (CD) by using a light flux from the third semiconductor laser LD2.

First, an axis line of a light flux from each of a first semiconductor laser LD1, a second semiconductor laser LD2, and a third semiconductor laser LD3, and an optical axis of each of a first objective lens section OBJ1 and a second objective lens section OBJ2 are adjusted respectively in such a way that each tilt of the light flux and the optical axis to a reference optical axis of an optical pickup apparatus is made 1° or less, and the first semiconductor laser LD1, the second semiconductor laser LD2, the third semiconductor laser LD3, the first objective lens section OBJ1 and the second objective lens section OBJ2 are mounted on the optical pickup apparatus.

Here, the tilt of an actuator base ACTB (namely, the second objective lens section OBJ2) is adjusted such that when the second objective lens section OBJ2 converges a light flux from the first semiconductor laser LD1 onto an information recording surface of a HD (OD2) being the second optical disk, a coma aberration on the converged light spot becomes smaller than a predetermined value. Here, instead of the actuator base ACTB, the tilt of an optical element OE to a lens holder HD may be adjusted.

Then, the position of the first semiconductor laser LD1 is adjusted in a direction perpendicular to the optical axis such that when the first objective lens section OBJ1 converges a light flux from the first semiconductor laser LD1 onto an information recording surface of a BD (OD1) being a first optical disk, the coma aberration of the converged light spot becomes smaller than a predetermined value. At this time, the first semiconductor laser LD1 having been moved in the direction perpendicular to the optical axis is used also for the second objective lens OBJ2. However, since the second objective lens OBJ2 is adapted to satisfy the conditional formula (1) for a light flux from the first semiconductor laser LD1, a change of a coma aberration is slight. If necessary, by conducting these adjustments repeatedly, the adjustment accuracy can be enhanced more.

Further, the second semiconductor laser LD2 is adjusted in a direction perpendicular to the optical axis such that when the second objective lens section OBJ2 converges a light flux from the second semiconductor laser LD2 onto an information recording surface of a DVD (OD3) being a third optical disk, the coma aberration of the converged light spot becomes smaller than a predetermined value. Furthermore, the third semiconductor laser LD3 is adjusted in a direction perpendicular to the optical axis such that when the second objective lens section OBJ2 converges a light flux from the third semiconductor laser LD3 onto an information recording surface of a CD (OD4) being a fourth optical disk, the coma aberration of the converged light spot becomes smaller than a predetermined value.

Here, in the case that the first objective lens section OBJ1 is designed to satisfy the conditional formula (1) for a light flux from the first semiconductor laser LD1 and the second objective lens section OBJ2 is designed to satisfy the conditional formula (2) for a light flux from the first semiconductor laser LD1, in the above assembling method, “the first objective lens section OBJ1” and “the second objective lens section OBJ2” may be replaced relatively with each other.

By the above adjustment, when a light flux irradiated from each semiconductor laser is converged, a coma aberration of a converged light spot can be suppressed as small as possible. Further, at the time of conducting actually recording or reproducing information (namely, at the time of an actual operation), a coma aberration caused by a warp of an optical disk, and a coma aberration caused by a remaining error may be corrected by driving a relative tilt changing section in accordance with signals from a photodetector. Of course, by adjusting a coma aberration at the time of assembly, the burden of the relative tilt changing section at the time of an actual operation can be reduced, whereby the tilt changing mechanism used at the time of an actual operation can be made in small size, saving energy, and at low cost. Further, instead of tilting an optical element, a coma aberration may be corrected by a coma aberration correcting section, such as a crystalline liquid. Furthermore, a technique to tilt an optical element and a coma aberration correcting section, such as a crystalline liquid may be used in combination.

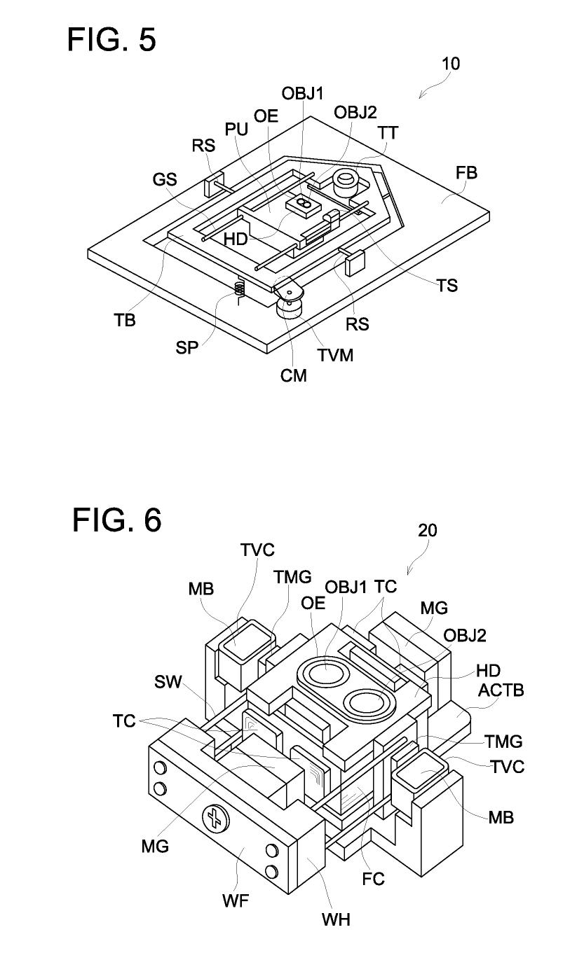

Here, an tilt changing mechanism 10 as the relative tilt changing section will be explained. FIG. 5 is a side view of the tilt changing mechanism 10 to adjust an tilt of an optical element OE (objective lens sections OBJ1, OBJ2) with the entire body of an optical pickup apparatus. In FIG. 5, an optical disk is mounted on a turntable TT by a magnet clamp (not illustrated in the drawings), and is rotated by a spindle motor (not illustrated in the drawings) attached to a fixing base FB. A tilt changing motor TVM attached with a cam CM is fixed to the fixing base FB, and it rotated by a driving power source (not illustrated in the drawings).

An optical pickup PU is held by a guide shaft GS fixed onto a tilting base TB, and is made movable to a radius direction of an optical disk by a shifting mechanism (not illustrated in the drawings). The tilting base TB is rotatably held by the fixing base FB through a rotating shaft RS, and is pressed onto the cam CM by a spring SP. At the time of recording and/or reproducing information, a tilt sensor TS detects a tilt of an optical disk, and the cam CM is rotated by the tilt changing motor TVM in accordance with the result of the detection in such a way that the tilting base TB is tilted to change a relative tilt between an optical disk and the optical pickup apparatus PU (namely, an objective lens), whereby a coma aberration of a light flux converged on an information recording surface of the optical disk can be controlled.

Since this method changes a relative tilt between an optical disk and an entire body of an optical pickup apparatus, it is effective regardless of the matter that which objective lens section of the present invention satisfies the conditional formula (1), or (2). Such a tilt changing mechanism to tilt an optical pickup apparatus is not limited to this method, and various methods are proposed in addition to the above method, for example, the official report of Japanese Patent Unexamined Publication No. 9-91731 disclosed in detail with regard to a tilt changing mechanism.

Next, a tilt changing mechanism 20 will be explained as another example of the relative tilt changing section. FIG. 6 is a perspective view of the tilt changing mechanism 20 to tilt an optical element OE with the entire body of a lens holder. In FIG. 6, the optical element OE comprising the objective lens sections OBJ1 and OBJ2 is fixed with adhesive to a lens holder HD. The lens-holder HD is held on a actuator base ACTB by a suspension wire SW through a wire holder WH holding a damping member and a wire fixed board WF. The coil FC for focusing and coil TC for tracking are being fixed to lens-holder HD, and the magnetic circuit is constituted with magnet MG fixed to actuator base ACTB which serves as a yoke, and actuator base ACTB. On the lens-holder HD, a coil FC for focusing and a coil TC for tracking are fixed so as to form a magnetic circuit together with an actuator base ACTB serving additionally as a yoke and a magnet MG fixed to the actuator base ACTB. A driving current is flowed to the focusing coil FC and the tracking coil TC from a driving power source (not illustrated in the drawings), whereby the lens-holder HD can be shifted in a focusing direction and a tracking direction.

Further, two magnets TMG for changing a tilt are fixed to the lens holder HD, and two coils TVC for changing a tilts are wound around a magnetic substance MB and fixed on the actuator base ACTB so as to oppose the above two magnets respectively, whereby the two magnets TMG and the two coils TVC form two magnetic circuits. With the above structure, the flow direction of a current flowing into each of the two coils TVC for changing tilt is controlled respectively such that the tow magnetic circuits generate two driving forces opposite in vertical direction to each other, whereby the lens holder HD can be tilted. With this control, a third order coma aberration of a light flux converged onto an information recording surface of an optical disk can be controlled.

Since this method changes a relative tilt between an optical disk and an objective lens section, as mentioned above, its effectiveness is high especially in the case that an objective lens section corresponding to a BD is designed to satisfy the conditional formula (2) and an objective lens section corresponding to a HD is designed to satisfy the conditional formula (1). Such a tilt changing mechanism to tilt a lens holder of an actuator is not limited to this method, and various methods are proposed in addition to the above method, for example, the official report of Japanese Patent Unexamined Publication No. 10-275354 disclosed in detail with regard to a tilt changing mechanism.

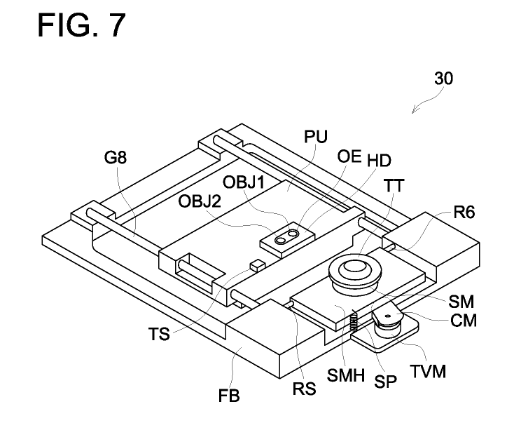

Further, a tilt changing mechanism 30 will be explained as another example of the relative tilt changing section. FIG. 7 is a perspective view of the tilt changing mechanism 30 to tilt an optical element OE with the entire body of an optical pickup apparatus. In FIG. 7, an optical disk is mounted on a turntable TT by a magnet clamp (not illustrated in the drawings), and is rotated by a spindle motor attached to a spindle motor holder SMH. An optical pickup PU is held by a guide shaft GS fixed onto a fixing base FB, and is made movable to a radius direction of an optical disk by a shifting mechanism (not illustrated in the drawings). The tilt changing motor TVM attached with a cam CM is fixed to the fixing base FB, and it rotated by a driving power source (not illustrated in the drawings). The spindle motor holder SMH is rotatably held by the fixing base FB through a rotating shaft RS, and is pressed onto the cam CM by a spring SP. At the time of recording and/or reproducing information, a tilt sensor TS detects a tilt of an optical disk, and the cam CM is rotated by the tilt changing motor TVM in accordance with the result of the detection in such a way that the spindle motor holder SMH is tilted to tilt an optical disk and to change a relative tilt between the optical disk and the optical pickup apparatus PU (namely, an objective lens), whereby a third order coma aberration of a light flux converged on an information recording surface of the optical disk can be controlled.

Since this method changes a relative tilt between an optical disk and an entire body of an optical pickup apparatus, it is effective regardless of the matter that the objective lens section of the present invention satisfies the conditional formula (1), or the conditional formula (2). Such a tilt changing mechanism to tilt a spindle motor is not limited to this method, and various methods are proposed in addition to the above method, for example, the official report of Japanese Patent Unexamined Publication No. 9-282692 disclosed in detail with regard to a tilt changing mechanism.

Furthermore, according to this embodiment, since two objective lens sections are provided in such a way that one objective lens section is used exclusively for a first semiconductor laser and another objective lens section is used in common for the first semiconductor laser, a second semiconductor laser and a third semiconductor laser, it is possible to provide an allowance in an optical design of an image forming performance for an optical disk corresponding to each wavelength. According to this feature, especially, since it becomes possible to make a lens thickness and an operation distance (working distance) small in design, it is very effective to design a thin type optical pickup apparatus. Further, since a margin in the specific aberration of an objective lens section becomes large, the aberration of other optic components of an optical pickup apparatus can be eased. Moreover, without requiring high mechanical precision of structural components of an optical pickup apparatus, it is possible to design an optical pickup apparatus excellent in mass production, whereby the cost of an optical pickup apparatus can be reduced.

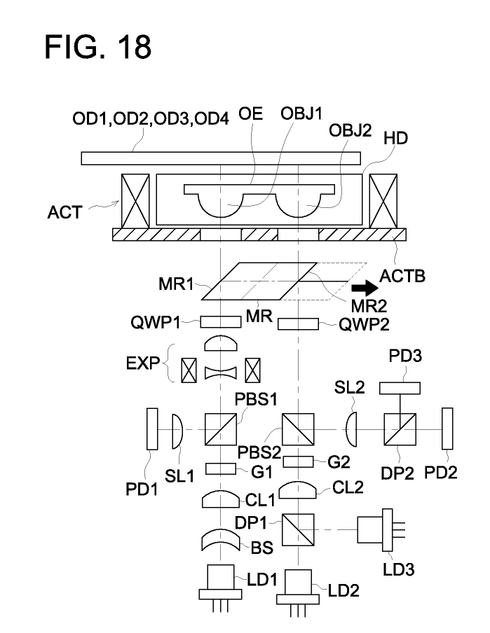

FIG. 18 is an outline cross sectional view showing a modified example of FIG. 15. The structure in FIG. 18 is the same as that in FIG. 15 except that the prism BSP and the dichroic prism DP3 are replaced with a reflective mirror MR comprising two reflective surfaces MR1 and MR2. Therefore, a detailed description for the structure is omitted. In the case that recording and/or reproducing information is conducted for BD (OD1) being the first optical disk, the reflective mirror MR is retracted in an arrow direction (at a location indicted with a dotted line) by a drive mechanism (not illustrated in the drawings). A light flux with a wavelength λ1 having passed through an expander lens EXP further passes through a first λ/4 wavelength plate QWP1, and is converged by a first objective lens section OBJ1 without being reflected by the reflective mirror MR onto an information recording surface of a BD (OD1) through its protecting layer (thickness t1=0.03 to 0.14 mm), and forms a converged light spot on it.

And then, the light flux is modulated by information pits on the information recording surface and is reflected on the information recording surface. The reflected light flux passes again through the first objective lens section OBJ1, the first λ/4 wavelength plate QWP1 and the expander lens EXP. Thereafter, the light flux is reflected by a first polarizing beam splitter PBS1 and enters into a light receiving surface of a first photodetector PD1 through a first sensor lens SL1, whereby recording and/or reproducing information is conducted for the BD (OD1) by output signals from the first photodetector PD1.

On the other hand, in the case that recording and/or reproducing information is conducted for HD (OD2) being the second optical disk, the reflective mirror MR is shifted to a location indicted with a solid line by a drive mechanism (not illustrated in the drawings) in FIG. 18. A light flux with a wavelength λ1 having passed through an expander lens EXP further passes through a first λ/4 wavelength plate QWP1. Then, the light flux is reflected by the reflective surface MR1, further reflected by the reflective surface MR2, and is converged by a second objective lens section OBJ2 having a diffractive structure onto an information recording surface of a HD (OD2) through its protecting layer (thickness t1=0.5 to 0.8 mm), and forms a converged light spot on it.

And then, the light flux is modulated by information pits on the information recording surface and is reflected on the information recording surface. The reflected light flux passes again through the second objective lens section OBJ2, is reflected the reflective surface MR2, further reflected by the reflective surface MR1, and passes through the first λ/4 wavelength plate QWP1 and the expander lens EXP. Thereafter, the light flux is reflected by the first polarizing beam splitter PBS1 and enters into the light receiving surface of the first photodetector PD1 through the first sensor lens SL1, whereby recording and/or reproducing information is conducted for the HD (OD2) by output signals from the first photodetector PD1.

In the case that recording and/or reproducing information is conducted for DVD (OD3) being the third optical disk, or in the case that recording and/or reproducing information is conducted for CD (OD4) being the fourth optical disk, the reflective mirror MR is shifted to a location indicted with a dotted line in FIG. 18. A light flux with a wavelength λ2 or a wavelength λ3 passes through a polarizing beam splitter PBS2 and a second λ/4 wavelength plate QWP2. Then, the light flux is adapted to pass through a central portion (a portion of a parallel flat plate) of the reflective mirror MR without entering into the reflective surfaces MR1 and MR2. Thereafter, the light flux with a wavelength λ2 or a wavelength λ3 having passed through the reflective mirror MR is converged by a second objective lens section OBJ2 having a diffractive structure onto an information recording surface of a DVD (OD3) through its protecting layer (thickness t2=0.5 to 0.8 mm) or onto an information recording surface of a CD (OD4) through its protecting layer (thickness t3=1.0 to 1.3 mm) respectively, and forms a converged light spot on it. Here, the reflective mirror MR may be retracted into a direction opposite to the arrowed mark in place of the location indicated with the dotted line in FIG. 18.

Thus, in the case of using the reflective mirror MR, a light flux can be converged onto both of the first optical disk and the second optical disk without losing an amount of the light flux. Therefore, since the burden of the first semiconductor laser LD1 can be eased, this embodiment is desirable especially for the case that recording is conducted at least of the first optical disk and the second optical disk with the use of a light flux from the first semiconductor laser LD1.

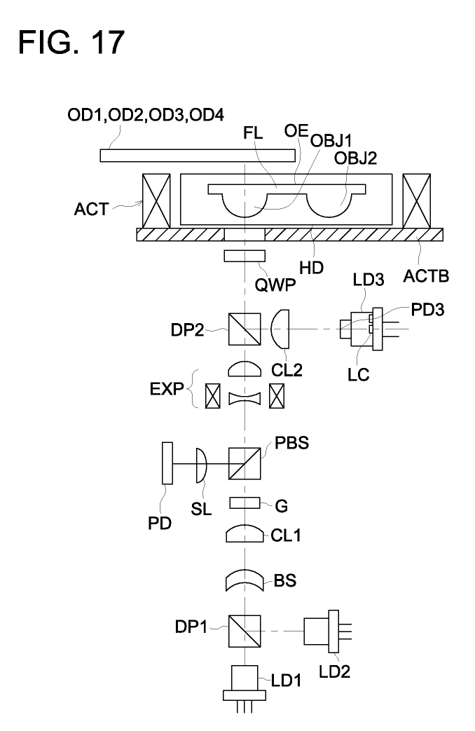

Next, the second embodiment will be described with reference to FIG. 17. FIG. 17 is an outline cross sectional view of an optical pickup apparatus in which recording and/or reproducing information can be conducted to all a BD (the first optical disk), a HD (the second optical disk), a DVD (the third optical disk), and a CD (the fourth optical disk). Here, the first objective lens section OBJ1 has only a refractive surface, and the second objective lens section OBJ2 is provided with a diffractive structure as an optical path difference providing structure for compatibility. Further, the first objective lens section and/or the second objective lens section may be provided with a diffractive structure as an optical path difference providing structure for correcting a change of a spherical aberration at the time that temperature changes or wavelength slightly changes so that their optical characteristic can be improved.

In the present embodiment, a first semiconductor laser LD1, a second semiconductor laser LD2 and a third semiconductor laser LD3 are also arranged independently as an example in which semiconductor laser sources are arranged independently without being accommodated in the same box.

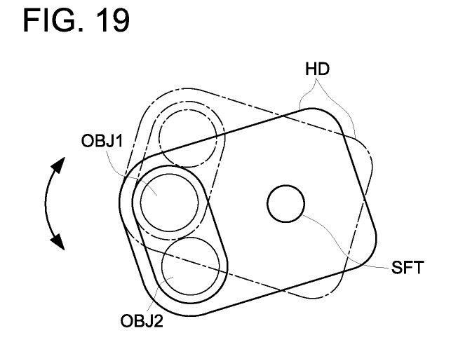

An optical element OE is the same as that of the embodiment mentioned above (refer to FIG. 4). As shown in FIG. 17, the lens holder HD is supported so as to be movable into at least two dimensional directions by an actuator ACT. The actuator ACT comprises an actuator base ACTB attached to a frame (not shown in the drawing) of an optical pickup apparatus so as to make its position adjustable. As shown in FIG. 19, the lens holder HD to support an objective lens section is made rotatable around a shaft SFT extending in parallel to both optical axes of two objective lens sections to be supported. As shown in FIG. 17, in the case that recording and/or reproducing information is conducted for the first optical disk OD1, the lens holder HD is rotated to a position where a light flux having passed through a λ/4 wavelength plate QWP is allowed to enter into the first objective lens section OBJ1. On the other hand, in the case that recording and/or reproducing information is conducted for the second optical disk OD2, the third optical disk OD3, or the fourth optical disk OD4, the lens holder HD is rotated to a position where a light flux having passed through a λ/4 wavelength plate QWP is allowed to enter into the second objective lens section OBJ2.

In the case that recording and/or reproducing information is conducted for the first optical disk OD1, the lens holder HD is rotated to the position shown in FIG. 17. In FIG. 17, a light flux emitted from the first semiconductor laser LD1 (wavelength λ1=350 nm to 440 nm) as a first light source passes through a dichroic prism DP1 and a beam shaper BS with which the shape of the light flux is corrected, and the light flux enters into first collimating lens CL1. The light flux exited from the first collimating lens CL1 passes through a diffractive grating element G being an optical section to divide a light flux emitted from a light source into a main beam used for recording and/or reproducing and a sub beam used for detecting a tracking error signal, and further the light flux passes through a polarizing beam splitter PBS and an expander lens EXP.

The light flux having passed through the expander lens EXP passes through a dichroic prism DP2, further passes through a λ/4 wavelength plate QWP, and is converged onto an information recording surface of a BD (OD1) being the first optical disk through its protecting layer (thickness t1=0.03 to 0.14 mm) by a first objective lens section OBJ1, and forms a converged light spot on it.

And then, the light flux is modulated by information pits on the information recording surface and is reflected on the information recording surface. The reflected light flux passes again through the first objective lens section OBJ1, the λ/4 wavelength plate QWP, the dichroic prism DP2, and the expander lens EXP. Thereafter, the light flux is reflected by a polarizing beam splitter PBS, and enters into a light receiving surface of a photodetector PD through a sensor lens SL, whereby recording and/or reproducing information is conducted for the BD (OD1) by output signals from the photodetector PD.

Moreover, an in-focus detection and a truck detection are conducted by detecting a change in the shape of a light spot and a change in the light amount due to a positional change on the photodetector PD. Based on this detection, an actuator ACT is driven to shift the first objective lens section OBJ1 with the entire body of the lens holder HD in such a way that a light flux from the first semiconductor laser LD1 is formed an image on the information recording surface of the first optical disk OD1.

In the case that recording and/or reproducing information is conducted for a HD (OD2) being a second optical disk, the lens holder HD is rotated from the position shown in FIG. 17. As a light source, the first semiconductor laser LD1 (wavelength λ1=350 nm to 440 nm) is used as same as ED, a light flux emitted from the first semiconductor laser LD1 passes through a beam shaper BS by which the shape of the light flux is corrected. Thereafter, the light flux enters into a first collimating lens CL1. The light flux exited from the first collimating lens CL1 passes through a diffractive grating element G being an optical section to divide a light flux emitted from a light source into a main beam for recording and/or reproducing information and a sub beam for detecting tracking error signals, and the light flux further passes through a polarizing beam splitter PBS and the expander lens EXP.

The light flux having passed through the expander lens EXP further passes through a dichroic prism DP2 and a λ/4 wavelength plate QWP. Then, the light flux is converged onto an information recording surface of a HD (OD2) through its protecting layer (thickness t1=0.5 to 0.8 mm) by a second objective lens section OBJ2 having a diffractive structure for compatibility, and forms a converged light spot on it.

And then, the light flux is modulated by information pits on the information recording surface and is reflected on the information recording surface. The reflected light flux passes again through the second objective lens section OBJ2, the λ/4 wavelength plate QWP, the dichroic prism DP2 and the expander lens EXP. Thereafter, the light flux is reflected by the polarizing beam splitter PBS and enters into the light receiving surface of the photodetector PD through the sensor lens SL, whereby recording and/or reproducing information is conducted for the HD (OD2) by output signals from the photodetector PD.

Moreover, an in-focus detection and a truck detection are conducted by detecting a change in the shape of a light spot and a change in the light amount due to a positional change on the photodetector PD. Based on this detection, an actuator ACT is driven to shift the second objective lens section OBJ2 with the entire body of the lens-holder HD in such a way that a light flux from the first semiconductor laser LD1 is formed an image on the information recording surface of the HD (OD2).

In the case that recording and/or reproducing information is conducted for a DVD (OD3) being a third optical disk, the lens holder HD is rotated from the position shown in FIG. 17 as same as in the case of a HD (OD2). A light flux emitted from the second semiconductor laser LD2 (wavelength λ2=600 nm to 700 nm) is reflected by a dichroic prism DP1, and passes through a beam shaper BS with which the shape of the light flux is corrected, and the light flux enters into first collimating lens CL1. The light flux exited from the first collimating lens CL1 passes through a diffractive grating element G being an optical section to divide a light flux emitted from a light source into a main beam used for recording and/or reproducing and a sub beam used for detecting a tracking error signal, and further the light flux passes through a polarizing beam splitter PBS and an expander lens EXP.

The light flux having passed through the expander lens EXP further passes through a dichroic prism DP2 and a λ/4 wavelength plate QWP. Then, the light flux is converged onto an information recording surface of a DVD (OD3) through its protecting layer (thickness t3=0.5 to 0.8 mm) by a second objective lens section OBJ2 having a diffractive structure, and forms a converged light spot on it.

And then, the light flux is modulated by information pits on the information recording surface and is reflected on the information recording surface. The reflected light flux passes again through the second objective lens section OBJ2, the λ/4 wavelength plate QWP, the dichroic prism DP2 and the expander lens EXP. Thereafter, the light flux is reflected by the polarizing beam splitter PBS and enters into the light receiving surface of the photodetector PD through the sensor lens SL, whereby recording and/or reproducing information is conducted for the DVD (OD3) by output signals from the photodetector PD.

Moreover, an in-focus detection and a truck detection are conducted by detecting a change in the shape of a light spot and a change in the light amount due to a positional change on the photodetector PD. Based on this detection, an actuator ACT is driven to shift the second objective lens section OBJ2 with the entire body of the lens-holder HD in such a way that a light flux from the second semiconductor laser LD2 is formed an image on the information recording surface of the DVD (OD3).

A third semiconductor laser LD3 is a hologram laser, and a laser chip LC being a light source and a photodetector PD3 is packaged together in one package. The case where recording and/or reproducing information is conducted for a CD (OD4) being the fourth optical disk will be explained. A light flux emitted from a laser chip of a third semiconductor laser LD3 (wavelength λ3=700 nm to 800 nm) enters into a second collimating lens CL2. Then, the light flux having passed through the second collimating lens CL2 is reflected by a dichroic prism DP2. Thereafter, the light flux is converged onto an information recording surface of a CD (OD4) through its protecting layer (thickness t3=1.0 to 1.3 mm) by the second objective lens section OBJ2 having a diffractive structure, and forms a converged light spot on it.

And then, the light flux is modulated by information pits on the information recording surface and is reflected on the information recording surface. The reflected light flux passes again through the second objective lens section OBJ2 and a λ/4 wavelength plate QWP, and is reflected by the dichroic prism DP2. Then, the reflected light flux is collected by the second collimating lens CL2, and enters into a light receiving surface of a third photodetector PD3 in the third semiconductor laser LD3, whereby recording and/or reproducing information is conducted for the CD (OD4) by output signals from the third photodetector PD3.

Moreover, an in-focus detection and a truck detection are conducted by detecting a change in the shape of a light spot and a change in the light amount due to a positional change on the third photodetector PD3. Based on this detection, the actuator ACT is driven to shift the second objective lens section OBJ2 with the entire body of the lens holder HD in such a way that a light flux from the third semiconductor laser LD3 is formed an image on the information recording surface of the CD (OD4).

Here, since the second objective lens section OBJ2 comprises an optical path difference providing structure like a diffractive structure, an aberration caused by a difference in thickness among transparent substrates of different optical disks is made to be cancelled by a aberration caused by the diffractive structure due to a difference in wavelength among light fluxes, whereby it makes it possible to record or reproduce different optical disks by a single objective lens section.

In the optical element of this embodiment, the first objective lens section OBJ1 is designed to satisfy the conditional formula (2) at the time of conducting recording and/or reproducing the first optical disk (BD) by using a light flux from the first semiconductor laser LD1, and the second objective lens section OBJ2 is designed to satisfy the conditional formula (1) at the time of conducting recording and/or reproducing the second optical disk (HD) by using a light flux from the first semiconductor laser LD1.

Further, the second objective lens section OBJ2 is designed to satisfy the conditional formula (2) at the time of conducting recording and/or reproducing the third optical disk (DVD) by using a light flux from the second semiconductor laser LD2. Furthermore, the second objective lens section OBJ2 is designed to satisfy the conditional formula (2) at the time of conducting recording and/or reproducing the fourth optical disk (CD) by using a light flux from the third semiconductor laser LD2. Here, since a method of assembling the optical element in this embodiment is the same as that in the first embodiment, the explanation for the method is omitted.

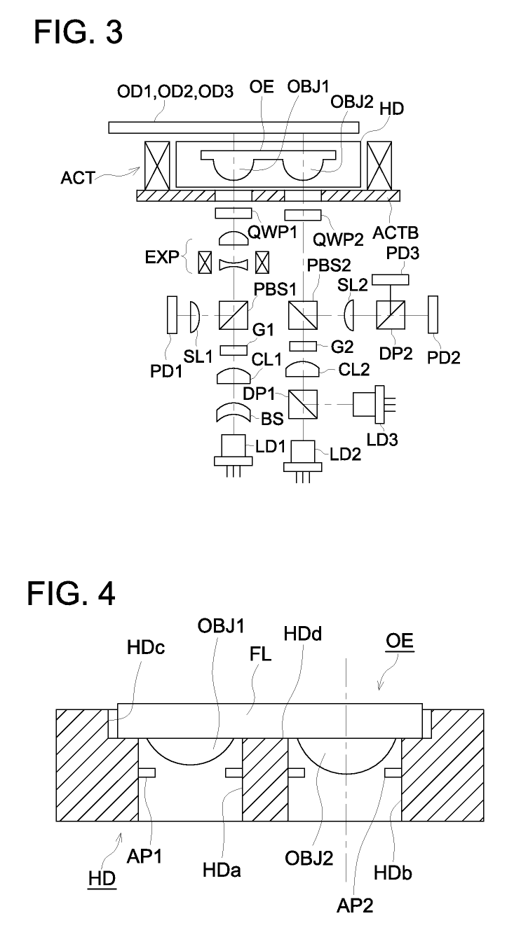

FIG. 3 is an outline cross sectional view of an optical pickup apparatus according to the third embodiment in which recording and/or reproducing information can be conducted to all of a BD (also referred to as a first optical disk), a conventional DVD (also referred to as a second optical disk), and a CD (also referred to as a third optical disk). FIG. 4 is a cross sectional view of an optical element OE constituted integrally by a technique to unite two objective lens sections and a lens holder HD to hold the optical element OE. Here, at least one of the first objective lens section and the second objective lens section may be provided with a diffractive structure as an optical path difference providing structure in such a way that their optical characteristic can be improved.

In FIG. 4, the optical element OE is integrally formed in one boy with the first objective lens section OBJ1 and the second objective lens section OBJ2 in such a way that the first objective lens section OBJ1 and the second objective lens section OBJ2 are linked with a plate-shaped flange FL so as to make their optical axes parallel to each other. In the lens holder HD, two openings HDa and HDb are formed such that their axis lines are almost parallel to each other. The upper part common to both of the openings HDa and HDb in the drawing is shaped to form a concave seat section HDc and the flange FL of the optical element OE is mounted to come in contact with the concave seat section HDc. On this condition, the opening HDa is positioned opposite to the first objective lens section OBJ1, and the opening HDb is positioned opposite to the second objective lens section OBJ2.

As shown in FIG. 3, the lens holder HD is supported so as to be movable into at least two dimensional directions by an actuator ACT. The actuator ACT comprises an actuator base ACTS attached to a frame (not shown in the drawing) of an optical pickup apparatus so as to make its position adjustable.

In the case that recording and/or reproducing information is conducted for BD (OD1) being a first optical disk, in FIG. 3, a light flux emitted from the first semiconductor laser LD1 (wavelength λ1=350 nm to 440 nm) as a first light source passes through a beam shaper BS with which the shape of the light flux is corrected, and the light flux enters into first collimating lens CL1. The light flux exited from the first collimating lens CL1 passes through a first diffractive grating element G1 being an optical section to divide a light flux emitted from a light source into a main beam used for recording and/or reproducing and a sub beam used for detecting a tracking error signal, and further the light flux passes through a first polarizing beam splitter PBS1 and an expander lens EXP.

The light flux having passed through the expander lens EXP further passes through a first λ/4 wavelength plate QWP1, and is converged onto an information recording surface of a BD (OD1) through its protecting layer (thickness t1=0.03 to 0.14 mm) by a first objective lens section OBJ1, and forms a converged light spot on it.

And then, the light flux is modulated by information pits on the information recording surface and is reflected on the information recording surface. The reflected light flux passes again through the first objective lens section OBJ1, the first λ/4 wavelength plate QWP1 and the expander lens EXP. Thereafter, the light flux is reflected by a first polarizing beam splitter PBS1 and enters into a light receiving surface of a first photodetector PD1 through a first sensor lens SL1, whereby recording and/or reproducing information is conducted for the BD (OD1) by output signals from the first photodetector PD1.

Moreover, an in-focus detection and a truck detection are conducted by detecting a change in the shape of a light spot and a change in the light amount due to a positional change on the first photodetector PD1. Based on this detection, an actuator ACT is driven to shift the first objective lens section OBJ1 with the entire body of the lens holder HD in such a way that a light flux from the first semiconductor laser LD1 is formed an image on the information recording surface of the BD (OD1).

In the case that recording and/or reproducing information is conducted for a DVD (OD2) being a second optical disk, a light flux emitted from a second semiconductor laser LD2 (wavelength λ2=600 nm to 700 nm) passes through a first dichroic prism DP1 and enters into a second collimating lens CL2. Then, the light flux passes through a second diffractive grating element G2, a second polarizing beam splitter PBS2, and a second λ/4 wavelength plate QWP2. Thereafter, the light flux is converged onto an information recording surface of a DVD (OD2) through its protecting layer (thickness t2=0.5 to 0.8 mm) by the second objective lens section OBJ2 having the diffractive structure, and forms a converged light spot on it.

And then, the light flux is modulated by information pits on the information recording surface and is reflected on the information recording surface. The reflected light flux passes again through the second objective lens section OBJ2 and the second λ/4 wavelength plate QWP2, reflected by the second polarizing beam splitter PBS2, and enters into a light receiving surface of a second photodetector PD2 through a second sensor lens SL2 and a second dichroic prism DP2, whereby recording and/or reproducing information is conducted for the DVD (OD2) by output signals from the second photodetector PD2.

Moreover, an in-focus detection and a truck detection are conducted by detecting a change in the shape of a light spot and a change in the light amount due to a positional change on the second photodetector PD2. Based on this detection, the actuator ACT is driven to shift the second objective lens section OBJ2 with the entire body of the lens holder HD in such a way that a light flux from the second semiconductor laser LD2 is formed an image on the information recording surface of the DVD (OD2).

In the case that recording and/or reproducing information is conducted for a CD (OD3) being a third optical disk, a light flux emitted from a third semiconductor laser LD3 (wavelength λ3=700 nm to 800 nm) is reflected by a first dichroic prism DP1, and enters into a second collimating lens CL2. Further, the light flux passes through the second diffractive grating element G2, the second polarizing beam splitter PBS2, and the second λ/4 wave plate QWP2. Thereafter, the light flux is converged onto an information recording surface of a CD (OD3) through its protecting layer (thickness t3=1.0 to 1.3 mm) by the second objective lens section OBJ2 having the diffractive structure, and forms a converged light spot on it.

And then, the light flux is modulated by information pits on the information recording surface and is reflected on the information recording surface. The reflected light flux passes again through the second objective lens section OBJ2 and the second λ/4 wavelength plate QWP2, and is reflected by the second polarizing beam splitter PBS2. Then, the light flux passes through a second sensor lens SL2, is reflected by the second dichroic prism DP2, and enters into a light receiving surface of a third photodetector PD3, whereby recording and/or reproducing information is conducted for the CD (OD3) by output signals from the third photodetector PD3.

Moreover, an in-focus detection and a truck detection are conducted by detecting a change in the shape of a light spot and a change in the light amount due to a positional change on the third photodetector PD3. Based on this detection, the actuator ACT is driven to shift the second objective lens section OBJ2 with the entire body of the lens holder HD in such a way that a light flux from the third semiconductor laser LD3 is formed an image on the information recording surface of the CD (OD3).

Here, since the second objective lens section OBJ2 comprises an optical path difference providing structure like a diffractive structure, an aberration caused by a difference in thickness among transparent substrates of different optical disks is made to be cancelled by a aberration caused by the diffractive structure due to a difference in wavelength among light fluxes, whereby it makes it possible to record or reproduce different optical disks by a single objective lens section.

A method of assembling an optical element according to this embodiment will be explained.

The optical element of this embodiment is premised such that the first objective lens section OBJ1 is designed to satisfy the conditional formula (1) for a light flux from the first semiconductor laser LD1, and the second objective lens section OBJ2 is designed to satisfy the conditional formula (2) for a light flux from the second semiconductor laser LD2 and the third semiconductor laser LD3. Especially, in the case of correcting a coma aberration due to a tilt of a BD being a first optical disk at the time of an actual operation, it is preferable that the first objective lens section OBJ1 satisfies the conditional formula (1) for a light flux from the first semiconductor laser LD1 and the second objective lens section OBJ2 satisfies the conditional formula (2) for a light flux from the second semiconductor laser LD2.

|HCM|/|TCM|<0.3 (1)

|HCM|/|TCM|>0.3 (2)

Here, HCM represents a view angle third order coma sensibility in the first objective lens section or the second objective lens section, and TCM represents a tilt angle third order coma sensibility in the first objective lens section or the second objective lens section.

First, an axis line of a light flux from each of a first semiconductor laser LD1, a second semiconductor laser LD2, and a third semiconductor laser LD3, and an optical axis of each of a first objective lens section OBJ1 and a second objective lens section OBJ2 are adjusted respectively in such a way that each tilt of the light flux and the optical axis to a reference optical axis of an optical pickup apparatus is made 1° or less, and the first semiconductor laser LD1, the second semiconductor laser LD2, the third semiconductor laser LD3, the first objective lens section OBJ1 and the second objective lens section OBJ2 are mounted on the optical pickup apparatus.

Here, the tilt of an actuator base ACTB (namely, the first objective lens section OBJ1) is adjusted such that when the first objective lens section OBJ1 converges a light flux from the first semiconductor laser LD1 onto an information recording surface of the first optical disk OD1, a third order coma aberration on the converged light spot becomes smaller than a predetermined value. Here, instead of the actuator base ACTB, the tilt of an optical element OE to a lens holder HD may be adjusted. In this case, it is no need to say that the optical element is not fixed with an adhesive to the lens holder HD before the above adjustment.

Then, the positions of the second semiconductor laser LD2 and the third semiconductor laser LD3 are adjusted in a direction perpendicular to the optical axis such that when the second objective lens section OBJ2 converges a light flux from the second semiconductor laser LD2 onto an information recording surface of each of the second optical disk OD2 and the third optical disk OD3, the coma aberration of the converged light spot becomes smaller than a predetermined value.

Here, in the case that the first objective lens section OBJ1 is designed to satisfy the conditional formula (2) for a light flux from the first semiconductor laser LD1 and the second objective lens section OBJ2 is designed to satisfy the conditional formula (1) for a light flux from the second semiconductor laser LD2, in the above assembling method, “the first objective lens section OBJ1” and “the second objective lens section OBJ2” may be replaced relatively with each other. Further, in this case, the second objective lens section OBJ2 may satisfies the conditional formula (1) or the conditional formula (2) for a light flux from the third semiconductor laser LD3. In the case that the second semiconductor laser LD2 and the third semiconductor laser LD3 are packaged together in one package and only the first semiconductor laser LD1 is made a separate element, it is preferable that the second objective lens section OBJ2 may satisfies the conditional formula (2) for a light flux from the third semiconductor laser LD3.

By the above adjustment, when a light flux irradiated from each semiconductor laser is converged, a coma aberration of a converged light spot can be suppressed as small as possible. Further, at the time of conducting actually recording or reproducing information, a coma aberration caused by a warp of an optical disk, and a coma aberration caused by a remaining error may be corrected by driving a relative tilt changing section in accordance with signals from a photodetector. Here, by adjusting a coma aberration at the time of assembly, the burden of the relative tilt changing section at the time of an actual operation can be reduced, whereby the tilt changing mechanism can be made in small size, to save energy, and at low cost.

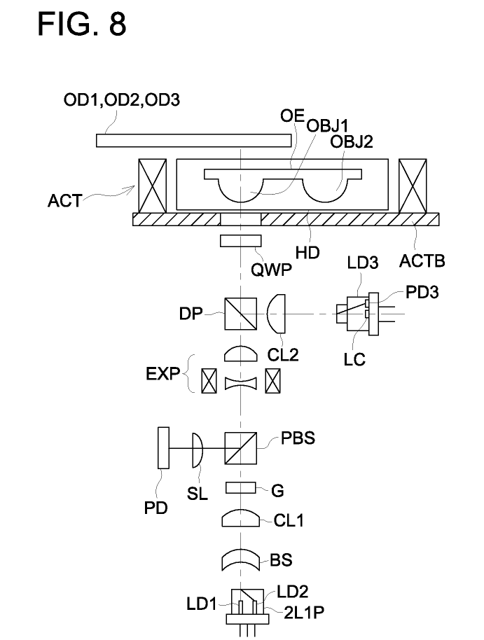

FIG. 8 is an outline cross sectional view of an optical pickup apparatus according to the fourth embodiment in which recording and/or reproducing information can be conducted to all of a BD (also referred to as a first optical disk), a conventional DVD (also referred to as a second optical disk), and a CD (also referred to as a third optical disk). In the present embodiment, a first semiconductor laser LD1 and a second semiconductor laser LD2 are accommodated in the same box to be a so-called two laser one package 2L1P.

An optical element OE is the same as that of the embodiment mentioned above (refer to FIG. 4). As shown in FIG. 8, a lens holder HD is supported so as to be movable into at least two dimensional directions by an actuator ACT. The actuator ACT comprises an actuator base ACTB attached to a frame (not shown in the drawing) of an optical pickup apparatus so as to make its position adjustable. As shown in FIG. 19, the lens holder HD to support an objective lens section is made rotatable around a shaft SFT extending in parallel to both optical axes of two objective lens sections to be supported. As shown in FIG. 8, in the case that recording and/or reproducing information is conducted for the first optical disk OD1, the lens holder HD is rotated to a position where a light flux having passed through a λ/4 wavelength plate QWP is allowed to enter into the first objective lens section OBJ1. On the other hand, in the case that recording and/or reproducing information is conducted for the second optical disk OD2 or the third optical disk OD3, the lens holder HD is rotated to a position where a light flux having passed through a λ/4 wavelength plate QWP is allowed to enter into the second objective lens section OBJ2.

In the case that recording and/or reproducing information is conducted for the first optical disk OD1, the lens holder HD is rotated to the position shown in FIG. 8. In FIG. 8, a light flux emitted from the first semiconductor laser LD1 (wavelength λ1=350 nm to 440 nm) as a first light source exits to the outside from the two laser one package 2L1P, and then passes through a beam shaper BS with which the shape of the light flux is corrected, and the light flux enters into first collimating lens CL1. The light flux exited from the first collimating lens CL1 passes through a diffractive grating element G being an optical section to divide a light flux emitted from a light source into a main beam used for recording and/or reproducing and a sub beam used for detecting a tracking error signal, and further the light flux passes through a polarizing beam splitter PBS and an expander lens EXP.

The light flux having passed through the expander lens EXP passes through a dichroic prism DP, further passes through a λ/4 wavelength plate QWP, and is converged onto an information recording surface of the first optical disk OD1 through its protecting layer (thickness t1=0.03 to 0.14 mm) by a first objective lens section OBJ1, and forms a converged light spot on it.

And then, the light flux is modulated by information pits on the information recording surface and is reflected on the information recording surface. The reflected light flux passes again through the first objective lens section OBJ1, the λ/4 wavelength plate QWP, the dichroic prism DP, and the expander lens EXP. Thereafter, the light flux is reflected by a polarizing beam splitter PBS, and enters into a light receiving surface of a photodetector PD through a sensor lens SL, whereby recording and/or reproducing information is conducted for the first optical disk (OD1) by output signals from the photodetector PD.

Moreover, an in-focus detection and a truck detection are conducted by detecting a change in the shape of a light spot and a change in the light amount due to a positional change on the photodetector PD. Based on this detection, an actuator ACT is driven to shift the first objective lens section OBJ1 with the entire body of the lens holder HD in such a way that a light flux from the first semiconductor laser LD1 is formed an image on the information recording surface of the first optical disk OD1.

In the case that recording and/or reproducing information is conducted for a second optical disk OD2, the lens holder HD is rotated from the position shown in FIG. 8. A light flux emitted from the second semiconductor laser LD2 (wavelength λ2=600 nm to 700 nm) exits to the outside from the two laser one package 2L1P, and then passes through a beam shaper BS with which the shape of the light flux is corrected, and the light flux enters into first collimating lens CL1. The light flux exited from the first collimating lens CL1 passes through a diffractive grating element G being an optical section to divide a light flux emitted from a light source into a main beam used for recording and/or reproducing and a sub beam used for detecting a tracking error signal, and further the light flux passes through a polarizing beam splitter PBS and an expander lens EXP.

The light flux having passed through the expander lens EXP further passes through a dichroic prism DP and a λ/4 wavelength plate QWP. Then, the light flux is converged onto an information recording surface of the second optical disk OD2 through its protecting layer (thickness t2=0.5 to 0.8 mm) by a second objective lens section OBJ2 having a diffractive structure, and forms a converged light spot on it.

And then, the light flux is modulated by information pits on the information recording surface and is reflected on the information recording surface. The reflected light flux passes again through the second objective lens section OBJ2, the λ/4 wavelength plate QWP, the dichroic prism DP and the expander lens EXP. Thereafter, the light flux is reflected by the polarizing beam splitter PBS and enters into the light receiving surface of the photodetector PD through the sensor lens SL, whereby recording and/or reproducing information is conducted for the second optical disk OD2 by output signals from the photodetector PD.

Moreover, an in-focus detection and a truck detection are conducted by detecting a change in the shape of a light spot and a change in the light amount due to a positional change on the photodetector PD. Based on this detection, an actuator ACT is driven to shift the second objective lens section OBJ2 with the entire body of the lens-holder HD in such a way that a light flux from the second semiconductor laser LD2 is formed an image on the information recording surface of the second (OD2).

A third semiconductor laser LD3 is a hologram laser, and a laser chip LC being a light source and a photodetector PD3 is packaged together in one package. The case where recording and/or reproducing information is conducted for the tird optical disk OD3 will be explained. A light flux emitted from a laser chip of a third semiconductor laser LD3 (wavelength λ3=700 nm to 800 nm) passes through o a second collimating lens CL2 with which a divergent angle of the light flux is changed. Then, the light flux is reflected by a dichroic prism DP. Thereafter, the light flux is converged onto an information recording surface of the third optical disk OD3 through its protecting layer (thickness t3=1.0 to 1.3 mm) by the second objective lens section OBJ2 having a diffractive structure, and forms a converged light spot on it.

And then, the light flux is modulated by information pits on the information recording surface and is reflected on the information recording surface. The reflected light flux passes again through the second objective lens section OBJ2 and a λ/4 wavelength plate QWP, and is reflected by the dichroic prism DP. Then, the reflected light flux is collected by the second collimating lens CL2, and enters into a light receiving surface of a third photodetector PD3 in the third semiconductor laser LD3, whereby recording and/or reproducing information is conducted for the third optical disk OD3 by output signals from the third photodetector PD3.

Moreover, an in-focus detection and a truck detection are conducted by detecting a change in the shape of a light spot and a change in the light amount due to a positional change on the third photodetector PD3. Based on this detection, the actuator ACT is driven to shift the second objective lens section OBJ2 with the entire body of the lens holder HD in such a way that a light flux from the third semiconductor laser LD3 is formed an image on the information recording surface of the third optical disk OD3.

Here, since the second objective lens section OBJ2 comprises an optical path difference providing structure like a diffractive structure, an aberration caused by a difference in thickness among transparent substrates of different optical disks is made to be cancelled by a aberration caused by the diffractive structure due to a difference in wavelength among light fluxes, whereby it makes it possible to record or reproduce different optical disks by a single objective lens section.

In the optical element of this embodiment, the first objective lens section OBJ1 is designed to satisfy the conditional formula (1) for a light flux from the first semiconductor laser LD1, and the second objective lens section OBJ2 is designed to satisfy the conditional formula (2) for a light flux from the second semiconductor laser LD and the third semiconductor laser LD3. At this time, a method of adjusting a third order coma aberration is conducted as follows. That is, the tilt of an actuator base ACTB (namely, the first objective lens section OBJ1) is adjusted such that when the first objective lens section OBJ1 converges a light flux from the first semiconductor laser LD1 onto an information recording surface of the first optical disk OD1, a third order coma aberration on the converged light spot becomes smaller than a predetermined value. Further, the position of the second semiconductor laser LD2 and the position of the third semiconductor laser LD3 are adjusted in a direction perpendicular to the optical axis such that when the second objective lens section OBJ2 converges a light flux from the second semiconductor laser LD2 onto an information recording surface of the second optical disk OD2 and when the second objective lens section OBJ2 converges a light flux from the third semiconductor laser LD3 onto an information recording surface of the third optical disk OD3, the coma aberration of each of the respective converged light spots becomes smaller than a predetermined value. At this time, since the two laser one package is applied for the first semiconductor laser LD1 and the second semiconductor laser LD2, if the position of the second semiconductor laser LD2 is adjusted, the first semiconductor laser LD1 is also moved together with the second semiconductor laser LD2. However, since the first objective lens OBJ1 is adapted to satisfy the conditional formula (1), a change of a third coma aberration is slight. If necessary, by a technique to conduct these adjustments repeatedly, the adjustment accuracy can be enhanced more.

By the above adjustment, when a light flux irradiated from each semiconductor laser is converged, a coma aberration of a converged light spot can be suppressed as small as possible. Further, at the time of conducting actually recording or reproducing information, a coma aberration caused by a warp of an optical disk, and a coma aberration caused by a remaining error are made to be corrected by driving a relative tilt changing section in accordance with signals from a photodetector. Here, by adjusting a coma aberration at the time of assembly, the burden of the relative tilt changing section at the time of an actual operation can be reduced, whereby the tilt changing mechanism can be made in small size, to save energy, and at low cost.

Furthermore, since two objective lens sections are provided in such a way that one objective lens section is used exclusively for a first semiconductor laser and another objective lens section is used in common for a second semiconductor laser and a third semiconductor laser, it is possible to provide an allowance in an optical design of an image forming performance for an optical disk corresponding to each wavelength. According to this feature, especially, since it becomes possible to make a lens thickness and an operation distance (working distance) small in design, it is very effective to design a thin type optical pickup apparatus. Further, since a margin in the specific aberration of an objective lens section becomes large, the aberration of other optic components of an optical pickup apparatus can be eased. Moreover, without requiring high mechanical precision of structural components of an optical pickup apparatus, it is possible to design an optical pickup apparatus excellent in mass production, whereby the cost of an optical pickup apparatus can be reduced.

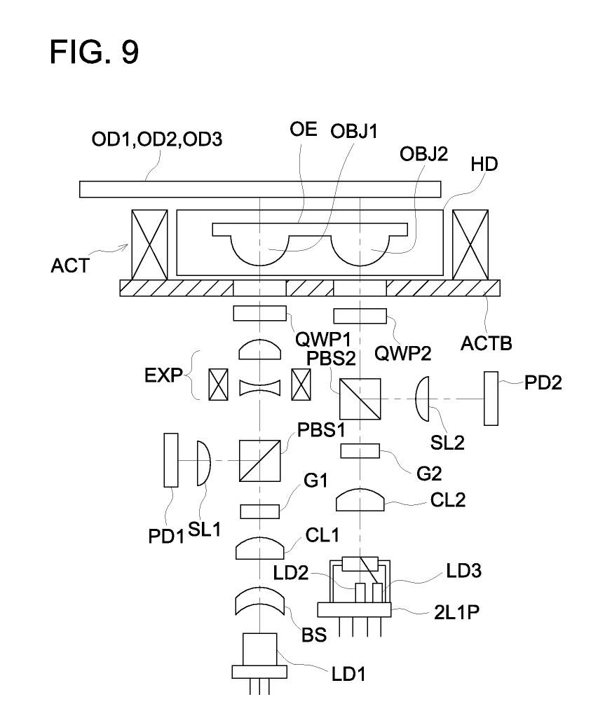

FIG. 9 is an outline cross sectional view of an optical pickup apparatus according to the fifth embodiment in which recording and/or reproducing information can be conducted to all of a BD (also referred to as a first optical disk), a conventional DVD (also referred to as a second optical disk), and a CD (also referred to as a third optical disk). In the present embodiment, a second semiconductor laser LD2 and a third semiconductor laser LD3 are accommodated in the same box to be a so-called two laser one package 2L1P.

An optical element OE is the same as that of the embodiment mentioned above (refer to FIG. 4). As shown in FIG. 9, a lens holder HD is supported so as to be movable into at least two dimensional directions by an actuator ACT.

In the case that recording and/or reproducing information is conducted for the first optical disk OD1, in FIG. 9, a light flux emitted from the first semiconductor laser LD1 (wavelength λ1=350 nm to 440 nm) as a first light source passes through a beam shaper BS with which the shape of the light flux is corrected, and the light flux enters into first collimating lens CL1. The light flux exited from the first collimating lens CL1 passes through a first diffractive grating element G1 being an optical section to divide a light flux emitted from a light source into a main beam used for recording and/or reproducing and a sub beam used for detecting a tracking error signal, and further the light flux passes through a first polarizing beam splitter PBS1 and an expander lens EXP.

The light flux having passed through the expander lens EXP further passes through a first λ/4 wavelength plate QWP1, and is converged onto an information recording surface of the first optical disk OD1 through its protecting layer (thickness t1=0.03 to 0.14 mm) by a first objective lens section OBJ1, and forms a converged light spot on it.

And then, the light flux is modulated by information pits on the information recording surface and is reflected on the information recording surface. The reflected light flux passes again through the first objective lens section OBJ1, the first λ/4 wavelength plate QWP1 and the expander lens EXP. Thereafter, the light flux is reflected by a first polarizing beam splitter PBS1 and enters into a light receiving surface of a first photodetector PD1 through a first sensor lens SL1, whereby recording and/or reproducing information is conducted for the first optical disk OD1 by output signals from the first photodetector PD1.

Moreover, an in-focus detection and a truck detection are conducted by detecting a change in the shape of a light spot and a change in the light amount due to a positional change on the first photodetector PD1. Based on this detection, an actuator ACT is driven to shift the first objective lens section OBJ1 with the entire body of the lens holder HD in such a way that a light flux from the first semiconductor laser LD1 is formed an image on the information recording surface of the first optical disk OD1.

In the case that recording and/or reproducing information is conducted for a second optical disk OD2, a light flux emitted from a second semiconductor laser LD2 (wavelength λ2=600 nm to 700 nm) exits to the outside from the two laser one package 2L1P, and then enters into a second collimating lens CL2. Then, the light flux exited from the second collimating lens CL2 passes through a second diffractive grating element G2, and further passes through a second polarizing beam splitter PBS2.

The light flux having passed through second polarizing beam splitter PBS2 passes through a second λ/4 wavelength plate QWP2, and is converged onto an information recording surface of the second optical disk OD2 through its protecting layer (thickness t2=0.5 to 0.8 mm) by the second objective lens section OBJ2 having the diffractive structure, and forms a converged light spot on it.

And then, the light flux is modulated by information pits on the information recording surface and is reflected on the information recording surface. The reflected light flux passes again through the second objective lens section OBJ2 and the second λ/4 wavelength plate QWP2, reflected by the second polarizing beam splitter PBS2, and enters into a light receiving surface of a second photodetector PD2 through a second sensor lens SL2, whereby recording and/or reproducing information is conducted for the second optical disk OD2 by output signals from the second photodetector PD2.

Moreover, an in-focus detection and a truck detection are conducted by detecting a change in the shape of a light spot and a change in the light amount due to a positional change on the second photodetector PD2. Based on this detection, the actuator ACT is driven to shift the second objective lens section OBJ2 with the entire body of the lens holder HD in such a way that a light flux from the second semiconductor laser LD2 is formed an image on the information recording surface of the second optical disk OD2.

In the case that recording and/or reproducing information is conducted for a third optical disk OD3, a light flux emitted from a third semiconductor laser LD3 (wavelength λ3=700 nm to 800 nm) exits to the outside from the two laser one package 2L1P, and enters into a second collimating lens CL2. Further, the light flux having passed through the second collimating lens CL2 passes through a second diffractive grating element G2, and further passed through a second polarizing beam splitter PBS2.

Then, the light flux having passed through the second polarizing beam splitter PBS2 passes through a second λ/4 wave plate QWP2, and is converged onto an information recording surface of the third optical disk OD3 through its protecting layer (thickness t3=1.0 to 1.3 mm) by the second objective lens section OBJ2 having the diffractive structure, and forms a converged light spot on it.

And then, the light flux is modulated by information pits on the information recording surface and is reflected on the information recording surface. The reflected light flux passes again through the second objective lens section OBJ2 and the second λ/4 wavelength plate QWP2, and is reflected by the second polarizing beam splitter PBS2. Then, the light flux enters into a light receiving surface of a second photodetector PD2 through a second sensor lens SL2, whereby recording and/or reproducing information is conducted for the third optical disk OD3 by output signals from the second photodetector PD2.

Moreover, an in-focus detection and a truck detection are conducted by detecting a change in the shape of a light spot and a change in the light amount due to a positional change on the second photodetector PD2. Based on this detection, the actuator ACT is driven to shift the second objective lens section OBJ2 with the entire body of the lens holder HD in such a way that a light flux from the third semiconductor laser LD3 is formed an image on the information recording surface of the third optical disk OD3.

Here, since the second objective lens section OBJ2 comprises an optical path difference providing structure like a diffractive structure, an aberration caused by a difference in thickness among transparent substrates of different optical disks is made to be cancelled by a aberration caused by the diffractive structure due to a difference in wavelength among light fluxes, whereby it makes it possible to record or reproduce different optical disks by a single objective lens section.

In the optical element of this embodiment, the first objective lens section OBJ1 is designed to satisfy the conditional formula (2) for a light flux from the first semiconductor laser LD1, and the second objective lens section OBJ2 is designed to satisfy the conditional formula (1) for a light flux from the second semiconductor laser LD and is designed to satisfy the conditional formula (2) for a light flux from the third semiconductor laser LD3. At this time, a method of adjusting a third order coma aberration is conducted as follows. That is, the tilt of an actuator base ACTB (namely, the second objective lens section OBJ2) is adjusted such that when the second objective lens section OBJ2 converges a light flux from the second semiconductor laser LD2 onto an information recording surface of the second optical disk OD2, a third order coma aberration on the converged light spot becomes smaller than a predetermined value. Further, the position of the first semiconductor laser LD1 is adjusted in a direction perpendicular to the optical axis such that when the first objective lens section OBJ1 converges a light flux from the first semiconductor laser LD1 onto an information recording surface of the first optical disk OD1, a third order coma aberration of the converged light spot becomes smaller than a predetermined value. Furthermore, the position of the third semiconductor laser LD3 is adjusted in a direction perpendicular to the optical axis such that when the second objective lens section OBJ2 converges a light flux from the third semiconductor laser LD3 onto an information recording surface of the third optical disk OD3, a third order coma aberration of the converged light spot becomes smaller than a predetermined value. At this time, since the two laser one package is applied for the second semiconductor laser LD2 and the third semiconductor laser LD3, if the position of the third semiconductor laser LD3 is adjusted, the second semiconductor laser LD2 is also moved together with the third semiconductor laser LD3. However, since the second objective lens OBJ2 is adapted to satisfy the conditional formula (1), a change of a third coma aberration is slight. If necessary, by a technique to conduct these adjustments repeatedly, the adjustment accuracy can be enhanced more.

By the above adjustment, when a light flux irradiated from each semiconductor laser is converged, a coma aberration of a converged light spot can be suppressed as small as possible. Further, at the time of conducting actually recording or reproducing information, a coma aberration caused by a warp of an optical disk, and a coma aberration caused by a remaining error are made to be corrected by driving a relative tilt changing section in accordance with signals from a photodetector. Here, by adjusting a coma aberration at the time of assembly, the burden of the relative tilt changing section at the time of an actual operation can be reduced, whereby the tilt changing mechanism can be made in small size, to save energy, and at low cost.

Furthermore, since two objective lens sections are provided in such a way that one objective lens section is used exclusively for a first semiconductor laser and another objective lens section is used in common for a second semiconductor laser and a third semiconductor laser, it is possible to provide an allowance in an optical design of an image forming performance for an optical disk corresponding to each wavelength. According to this feature, especially, since it becomes possible to make a lens thickness and an operation distance (working distance) small in design, it is very effective to design a thin type optical pickup apparatus. Further, since a margin in the specific aberration of an objective lens section becomes large, the aberration of other optic components of an optical pickup apparatus can be eased. Moreover, without requiring high mechanical precision of structural components of an optical pickup apparatus, it is possible to design an optical pickup apparatus excellent in mass production, whereby the cost of an optical pickup apparatus can be reduced.

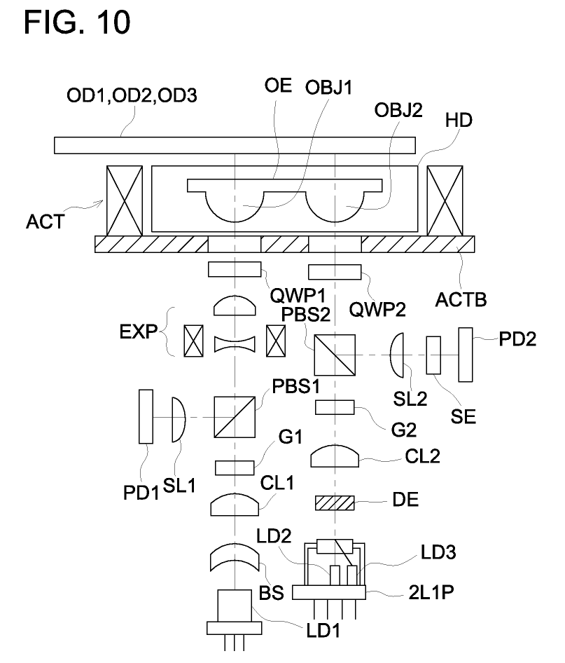

FIG. 10 is an outline cross sectional view of an optical pickup apparatus according to the sixth embodiment in which recording and/or reproducing information can be conducted to all of a BD (also referred to as a first optical disk), a conventional DVD (also referred to as a second optical disk), and a CD (also referred to as a third optical disk). In the present embodiment, a second semiconductor laser LD2 and a third semiconductor laser LD3 are accommodated in the same box to be a so-called two laser one package 2L1P.

An optical element OE is the same as that of the embodiment mentioned above (refer to FIG. 4). As shown in FIG. 10, a lens holder HD is supported so as to be movable into at least two dimensional directions by an actuator ACT.

In the case that recording and/or reproducing information is conducted for the first optical disk OD1, in FIG. 10, a light flux emitted from the first semiconductor laser LD1 (wavelength λ1=350 nm to 440 nm) as a first light source passes through a beam shaper BS with which the shape of the light flux is corrected, and the light flux enters into first collimating lens CL1. The light flux exited from the first collimating lens CL1 passes through a first diffractive grating element G1 being an optical section to divide a light flux emitted from a light source into a main beam used for recording and/or reproducing and a sub beam used for detecting a tracking error signal, and further the light flux passes through a first polarizing beam splitter PBS1 and an expander lens EXP.

The light flux having passed through the expander lens EXP further passes through a first λ/4 wavelength plate QWP1, and is converged onto an information recording surface of the first optical disk OD1 through its protecting layer (thickness t1=0.03 to 0.14 mm) by a first objective lens section OBJ1, and forms a converged light spot on it.

And then, the light flux is modulated by information pits on the information recording surface and is reflected on the information recording surface. The reflected light flux passes again through the first objective lens section OBJ1, the first λ/4 wavelength plate QWP1 and the expander lens EXP. Thereafter, the light flux is reflected by a first polarizing beam splitter PBS1 and enters into a light receiving surface of a first photodetector PD1 through a first sensor lens SL1, whereby recording and/or reproducing information is conducted for the first optical disk OD1 by output signals from the first photodetector PD1.

Moreover, an in-focus detection and a truck detection are conducted by detecting a change in the shape of a light spot and a change in the light amount due to a positional change on the first photodetector PD1. Based on this detection, an actuator ACT is driven to shift the first objective lens section OBJ1 with the entire body of the lens holder HD in such a way that a light flux from the first semiconductor laser LD1 is formed an image on the information recording surface of the first optical disk OD1.

In the case that recording and/or reproducing information is conducted for a second optical disk OD2, a light flux emitted from a second semiconductor laser LD2 (wavelength λ2=600 nm to 700 nm) exits to the outside from the two laser one package 2L1P, and then enters into a second collimating lens CL2. Then, the light flux exited from the second collimating lens CL2 passes through a second diffractive grating element G2, and further passes through a second polarizing beam splitter PBS2.

The light flux having passed through second polarizing beam splitter PBS2 passes through a second λ/4 wavelength plate QWP2, and is converged onto an information recording surface of the second optical disk OD2 through its protecting layer (thickness t2=0.5 to 0.8 mm) by the second objective lens section OBJ2 having the diffractive structure, and forms a converged light spot on it.

And then, the light flux is modulated by information pits on the information recording surface and is reflected on the information recording surface. The reflected light flux passes again through the second objective lens section OBJ2 and the second λ/4 wavelength plate QWP2, reflected by the second polarizing beam splitter (also referred to as a separating section) PBS2, and enters into a light receiving surface of a second photodetector PD2 through a second sensor lens SL2 and an optical axis correcting element SE, whereby recording and/or reproducing information is conducted for the second optical disk OD2 by output signals from the second photodetector PD2.

Moreover, an in-focus detection and a truck detection are conducted by detecting a change in the shape of a light spot and a change in the light amount due to a positional change on the second photodetector PD2. Based on this detection, the actuator ACT is driven to shift the second objective lens section OBJ2 with the entire body of the lens holder HD in such a way that a light flux from the second semiconductor laser LD2 is formed an image on the information recording surface of the second optical disk OD2.

In the case that recording and/or reproducing information is conducted for a third optical disk OD3, a light flux emitted from a third semiconductor laser LD3 (wavelength λ3=700 nm to 800 nm) exits to the outside from the two laser one package 2L1P, and enters into a second collimating lens CL2. Further, the light flux having passed through the second collimating lens CL2 passes through a second diffractive grating element G2, and further passed through a second polarizing beam splitter PBS2.

Then, the light flux having passed through the second polarizing beam splitter PBS2 passes through a second λ/4 wave plate QWP2, and is converged onto an information recording surface of the third optical disk OD3 through its protecting layer (thickness t3=1.0 to 1.3 mm) by the second objective lens section OBJ2 having the diffractive structure, and forms a converged light spot on it.

And then, the light flux is modulated by information pits on the information recording surface and is reflected on the information recording surface. The reflected light flux passes again through the second objective lens section OBJ2 and the second λ/4 wavelength plate QWP2, and is reflected by the second polarizing beam splitter PBS2. Then, the light flux enters into a light receiving surface of a second photodetector PD2 through a second sensor lens SL2 and an optical axis correcting element SE, whereby recording and/or reproducing information is conducted for the third optical disk OD3 by output signals from the second photodetector PD2.

Moreover, an in-focus detection and a truck detection are conducted by detecting a change in the shape of a light spot and a change in the light amount due to a positional change on the second photodetector PD2. Based on this detection, the actuator ACT is driven to shift the second objective lens section OBJ2 with the entire body of the lens holder HD in such a way that a light flux from the third semiconductor laser LD3 is formed an image on the information recording surface of the third optical disk OD3.

Here, since the second objective lens section OBJ2 comprises an optical path difference providing structure like a diffractive structure, an aberration caused by a difference in thickness among transparent substrates of different optical disks is made to be cancelled by a aberration caused by the diffractive structure due to a difference in wavelength among light fluxes, whereby it makes it possible to record or reproduce different optical disks by a single objective lens section.

In the optical element of this embodiment, the first objective lens section OBJ1 is designed to satisfy the conditional formula (1) for a light flux from the first semiconductor laser LD1, and the second objective lens section OBJ2 is designed to satisfy the conditional formula (2) for a light flux from the second semiconductor laser LD and the third semiconductor laser LD3 respectively. Here, since the two laser one package is applied for the second semiconductor laser LD and the third semiconductor laser LD3, the positions of these lasers are not adjusted independently from each other. However, when a light flux exited from the two laser one package enters into a diffractive element DE, a coma aberration can be corrected by the diffractive element DE. Here, the amount of correction is changed in accordance with an amount of rotation of the diffractive element DE. Therefore, at the time of assembling an optical pickup apparatus, in the case of conducting a shift adjustment for the third semiconductor laser LD3, the shift adjustment can be conducted by rotating the diffractive element DE appropriately in place of shifting the third semiconductor laser LD3 in a direction perpendicular to the optical axis. Here, the optical axis correcting element SE adjusts the position of a light spot of each of the second and third semiconductor lasers LD2 and LD3 to correct a deviation of the light spot on the light receiving surface of the second photodetector PD2 after the shift adjustment was conducted by the above diffractive element DE.

By the above adjustment, when a light flux irradiated from each semiconductor laser is converged, a coma aberration of a converged light spot can be suppressed as small as possible. Further, at the time of conducting actually recording or reproducing information, a coma aberration caused by a warp of an optical disk, and a coma aberration caused by a remaining error are made to be corrected by driving a relative tilt changing section in accordance with signals from a photodetector. Here, by adjusting a coma aberration at the time of assembly, the burden of the relative tilt changing section at the time of an actual operation can be reduced, whereby the tilt changing mechanism can be made in small size, to save energy, and at low cost.

Furthermore, since two objective lens sections are provided in such a way that one objective lens section is used exclusively for a first semiconductor laser and another objective lens section is used in common for a second semiconductor laser and a third semiconductor laser, it is possible to provide an allowance in an optical design of an image forming performance for an optical disk corresponding to each wavelength. According to this feature, especially, since it becomes possible to make a lens thickness and an operation distance (working distance) small in design, it is very effective to design a thin type optical pickup apparatus. Further, since a margin in the specific aberration of an objective lens section becomes large, the aberration of other optic components of an optical pickup apparatus can be eased. Moreover, without requiring high mechanical precision of structural components of an optical pickup apparatus, it is possible to design an optical pickup apparatus excellent in mass production, whereby the cost of an optical pickup apparatus can be reduced.

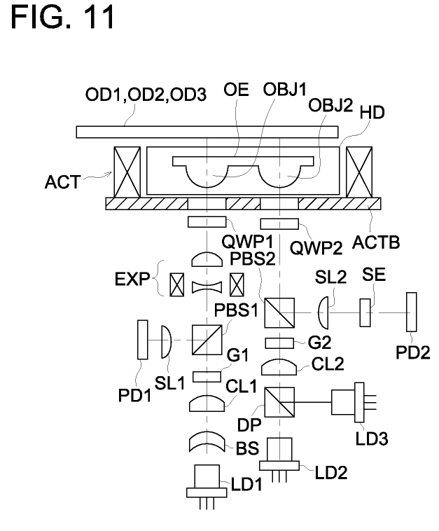

FIG. 11 is an outline cross sectional view of an optical pickup apparatus according to the seventh embodiment in which recording and/or reproducing information can be conducted to all of a BD (also referred to as a first optical disk), a conventional DVD (also referred to as a second optical disk), and a CD (also referred to as a third optical disk).

An optical element OE is the same as that of the embodiment mentioned above (refer to FIG. 4). As shown in FIG. 11, a lens holder HD is supported so as to be movable into at least two dimensional directions by an actuator ACT.

In the case that recording and/or reproducing information is conducted for the first optical disk OD1, in FIG. 11, a light flux emitted from the first semiconductor laser LD1 (wavelength λ1=350 nm to 440 nm) as a first light source passes through a beam shaper BS with which the shape of the light flux is corrected, and the light flux enters into first collimating lens CL1. The light flux exited from the first collimating lens CL1 passes through a first diffractive grating element G1 being an optical section to divide a light flux emitted from a light source into a main beam used for recording and/or reproducing and a sub beam used for detecting a tracking error signal, and further the light flux passes through a first polarizing beam splitter PBS1 and an expander lens EXP.

The light flux having passed through the expander lens EXP further passes through a first λ/4 wavelength plate QWP1, and is converged onto an information recording surface of the first optical disk OD1 through its protecting layer (thickness t1=0.03 to 0.14 mm) by a first objective lens section OBJ1, and forms a converged light spot on it.

And then, the light flux is modulated by information pits on the information recording surface and is reflected on the information recording surface. The reflected light flux passes again through the first objective lens section OBJ1, the first λ/4 wavelength plate QWP1 and the expander lens EXP. Thereafter, the light flux is reflected by a first polarizing beam splitter PBS1 and enters into a light receiving surface of a first photodetector PD1 through a first sensor lens SL1, whereby recording and/or reproducing information is conducted for the first optical disk OD1 by output signals from the first photodetector PD1.

Moreover, an in-focus detection and a truck detection are conducted by detecting a change in the shape of a light spot and a change in the light amount due to a positional change on the first photodetector PD1. Based on this detection, an actuator ACT is driven to shift the first objective lens section OBJ1 with the entire body of the lens holder HD in such a way that a light flux from the first semiconductor laser LD1 is formed an image on the information recording surface of the first optical disk OD1.

In the case that recording and/or reproducing information is conducted for a second optical disk OD2, a light flux emitted from a second semiconductor laser LD2 (wavelength λ2=600 nm to 700 nm) passes through a dichroic prism DP, and enters into a second collimating lens CL2. Then, the light flux exited from the second collimating lens CL2 passes through a second diffractive grating element G2, and further passes through a second polarizing beam splitter PBS2.

The light flux having passed through the second polarizing beam splitter PBS2 passes through a second λ/4 wavelength plate QWP2, and is converged onto an information recording surface of the second optical disk OD2 through its protecting layer (thickness t2=0.5 to 0.8 mm) by the second objective lens section OBJ2 having the diffractive structure, and forms a converged light spot on it.

And then, the light flux is modulated by information pits on the information recording surface and is reflected on the information recording surface. The reflected light flux passes again through the second objective lens section OBJ2 and the second λ/4 wavelength plate QWP2, reflected by the second polarizing beam splitter (also referred to as a separating section) PBS2, and enters into a light receiving surface of a second photodetector PD2 through a second sensor lens SL2 and an optical axis correcting element, whereby recording and/or reproducing information is conducted for the second optical disk OD2 by output signals from the second photodetector PD2. Here, the optical axis correcting element SE corrects a deviation of an optical axis when a shift processing was conducted for at least one of the second semiconductor laser LD2 and the third semiconductor laser LD3, whereby the optical axis correcting element SE performs to converge a light flux emitted from any one of the second semiconductor laser LD2 and the third semiconductor laser LD3 at an optimum position on the light receiving surface of the second photodetector PD2.

Moreover, an in-focus detection and a truck detection are conducted by detecting a change in the shape of a light spot and a change in the light amount due to a positional change on the second photodetector PD2. Based on this detection, the actuator ACT is driven to shift the second objective lens section OBJ2 with the entire body of the lens holder HD in such a way that a light flux from the second semiconductor laser LD2 is formed an image on the information recording surface of the second optical disk OD2.

In the case that recording and/or reproducing information is conducted for a third optical disk OD3, a light flux emitted from a third semiconductor laser LD3 (wavelength λ3=700 nm to 800 nm) is reflected by a dichroic prism DP, and enters into a second collimating lens CL2. Further, the light flux having passed through the second collimating lens CL2 passes through a second diffractive grating element G2, and further passed through a second polarizing beam splitter PBS2.

Then, the light flux having passed through the second polarizing beam splitter PBS2 passes through a second λ/4 wave plate QWP2, and is converged onto an information recording surface of the third optical disk OD3 through its protecting layer (thickness t3=1.0 to 1.3 mm) by the second objective lens section OBJ2 having the diffractive structure, and forms a converged light spot on it.

And then, the light flux is modulated by information pits on the information recording surface and is reflected on the information recording surface. The reflected light flux passes again through the second objective lens section OBJ2 and the second λ/4 wavelength plate QWP2, and is reflected by the second polarizing beam splitter PBS2. Then, the light flux enters into a light receiving surface of a second photodetector PD2 through a second sensor lens SL2 and an optical axis correcting element, whereby recording and/or reproducing information is conducted for the third optical disk OD3 by output signals from the second photodetector PD2.

Moreover, an in-focus detection and a truck detection are conducted by detecting a change in the shape of a light spot and a change in the light amount due to a positional change on the second photodetector PD2. Based on this detection, the actuator ACT is driven to shift the second objective lens section OBJ2 with the entire body of the lens holder HD in such a way that a light flux from the third semiconductor laser LD3 is formed an image on the information recording surface of the third optical disk OD3.

Here, since the second objective lens section OBJ2 comprises an optical path difference providing structure like a diffractive structure, an aberration caused by a difference in thickness among transparent substrates of different optical disks is made to be cancelled by a aberration caused by the diffractive structure due to a difference in wavelength among light fluxes, whereby it makes it possible to record or reproduce different optical disks by a single objective lens section.

At the time of assembling of an optical pickup apparatus of this embodiment, the coma adjustment mentioned above may be conducted.

By the above adjustment, when a light flux irradiated from each semiconductor laser is converged, a coma aberration of a converged light spot can be suppressed as small as possible. Further, at the time of conducting actually recording or reproducing information, a coma aberration caused by a warp of an optical disk, and a coma aberration caused by a remaining error are made to be corrected by driving a relative tilt changing section in accordance with signals from a photodetector. Here, by adjusting a coma aberration at the time of assembly, the burden of the relative tilt changing section at the time of an actual operation can be reduced, whereby the tilt changing mechanism can be made in small size, to save energy, and at low cost.

Furthermore, since two objective lens sections are provided in such a way that one objective lens section is used exclusively for a first semiconductor laser and another objective lens section is used in common for a second semiconductor laser and a third semiconductor laser, it is possible to provide an allowance in an optical design of an image forming performance for an optical disk corresponding to each wavelength. According to this feature, especially, since it becomes possible to make a lens thickness and an operation distance (working distance) small in design, it is very effective to design a thin type optical pickup apparatus. Further, since a margin in the specific aberration of an objective lens section becomes large, the aberration of other optic components of an optical pickup apparatus can be eased. Moreover, without requiring high mechanical precision of structural components of an optical pickup apparatus, it is possible to design an optical pickup apparatus excellent in mass production, whereby the cost of an optical pickup apparatus can be reduced.

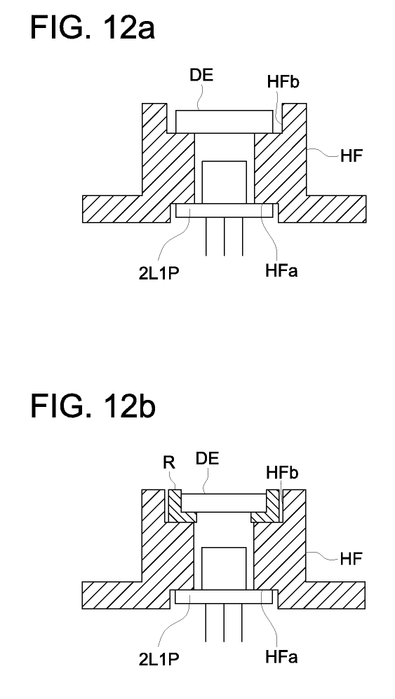

FIG. 12 is a cross sectional view showing two examples to hold a light source with a structure of a two laser one package and a diffractive element, and these examples can be applied the above mentioned embodiment employing a two laser one package and a diffractive element. In FIG. 12(a), a two laser one package 2L1P is mounted in a concave seat section HFa provided at a lower surface of an almost hollow cylinder-shaped holding flame HF, and a diffractive element DE is mounted in a concave seat section HFb at an upper surface of the flame HF. Here, at the time of assembling, it is preferable to fix the diffractive element DE with an adhesive after the diffractive element DE has been rotated in the concave seat section HFb.

In FIG. 12(b), a two laser one package 2L1P is mounted in a concave seat section HFa provided at a lower surface of an almost hollow cylinder-shaped holding flame HF, and a diffractive element DE is mounted through a ring-shaped supporting section R in a concave seat section HFb at an upper surface of the flame HF. Here, at the time of assembling, it is preferable to fix the diffractive element DE with an adhesive after the diffractive element DE has been rotated in the concave seat section HFb.

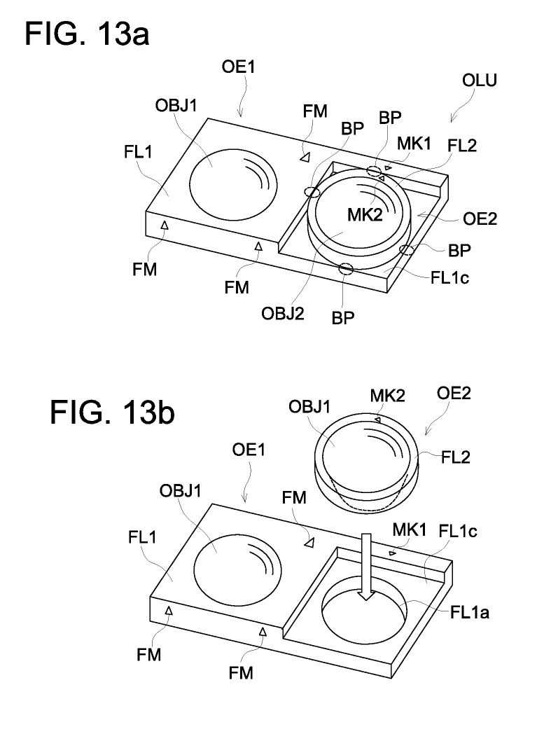

FIG. 13 is an illustration showing a modified example of the optical element OE. FIG. 13(a) is a perspective view of an objective lens unit of this embodiment, and FIG. 13(b) is a perspective view explaining a method of assembling the objective lens unit OLU shown in FIG. 13 (a). In the objective lens unit OLU shown in these figures, a first flange section FL1 of the first element OE1 is shaped in a rectangular plate, and at one end of the first flange section FL1, a shallow rectangular-shaped step section FL1c and an opening FL1a are formed.

A second element OE2 is mounted on the rectangular-shaped step section FL1c of the first element OE1 on the condition that the second element OE2 is rotatable. With this structure, the rotational attitude of the second objective lens section OBJ2 can be adjusted on the rectangular-shaped step section FL1c, whereby the orientation of an aberration, such as an astigmatism and a coma aberration of the second objective lens section OBJ2 can be adjusted. On the condition that the adjustment of a rotational position and a angle setting of the second objective lens section OBJ2 has been completed, for example, the second objective lens section OBJ2 is fixed to the rectangular-shaped step section FL1c with four jointing sections BP provided around the periphery of the second objective lens section OBJ2 by the use of a UV curable resin.

On the first flange section FL1 of the first element OE1, an index FM constituted by concavo-convexes is formed at a proper place on the surface. Such an index FM is adapted to include information about, for example, the position of a gate at the time of manufacturing the first member OE1 by an injection molding. By the provision of such an index FM, the index FM can be useful for a product control including a quality at the time of attaching an objective lens unit OLU to an optical pickup apparatus.

In the above objective lens unit OLU, the lowermost end of the second objective lens section OBJ2 is in the light source side and is protruded above than the uppermost end of an optical information recording medium side. Such a protrusion becomes so remarkable as the numerical aperture NA at the image side (optical information recording medium side) of the second objective lens section OBJ2 becomes larger. On the other hand, a second flange set FL2 is supported by the rectangular-shaped step section FL1c. Therefore, since the lowermost end of the second objective lens section OBJ2 is arranged so as to be embed in an opening FL1a functioning as an aperture diaphragm of the rectangular-shaped step section FL1c, it becomes possible to reduce the protruding amount that the lowermost end of the second objective lens section OBJ2 protrudes from the lower circle of the first flange section FL1. With this structure, the objective lens unit OLU can be made into a thin shape, whereby it becomes easy to mount it into an optical pickup apparatus and the optical pickup apparatus can be made in a small size. Further, since the opening FL1a of the rectangular-shaped step section FL1c can act as an aperture diaphragm, and it can contribute more to make the optical pickup apparatus in a small size. At this time, based on measurements by an interferometer (not shown in the drawings), it is preferable to coincident the orientation of a third order coma aberration between the first objective lens section OBJ1 and the second objective lens section OBJ2 (for example, to adjust the difference within 30 degrees).

Further, in the case that the difference between the orientation of a third order coma aberration of a first objective lens section and the orientation of a third order coma aberration of a second objective lens is 30 degrees or less, it is desirable that a objective lens section satisfying the conditional formula (2) satisfies the following conditional formula (2′).

0.6>|HCM|/|TCM|>0.3 (2′)

As stated above, according to an optical element in this embodiment, an optical pickup apparatus employing the optical element, and an assembling method, although two objective sections are formed in one body, a coma adjustment is optimized for each light flux emitted from a first to third semiconductor laser, The optical pickup apparatus has an excellent function to record and reproduce information for different kinds of optical disks and can be made in a compact size. Moreover, in the case that an optical pickup apparatus has an tilt changing mechanism, since the burden of an tilt changing mechanism in a coma suppressing function can be reduced by optimization of a coma adjustment at the time of adjusting a coma aberration, an tilt changing mechanism and a drive circuit for it can be produced easily at low cost in a small size.

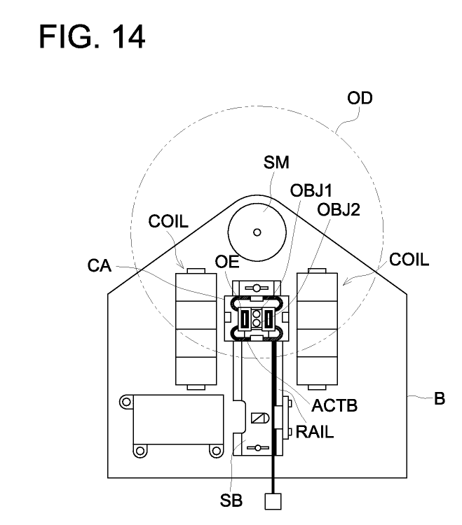

FIG. 14 is a view looking an example of an optical pickup apparatus from the top surface, for example, is the same as that disclosed by Japanese Patent Unexamined Publication No. 6-215384. A seek base SB is arranged at a central portion of a drive base B on which a spindle motor SM to drive an optical disk OD is mounted. At a side of the seek base SB, a rail RAIL for shifting is arranged. Along this rail RAIL, a pair of coil groups COIL is extended, and a coarse actuator CA is arranged to move in a direction of a radius of an optical disk OD with a guide of the pair of coil groups COIL. The coarse actuator CA supports an actuator base ACTB to drive an integrated optical element OE.

As mentioned above, the present invention has been explained with reference to the embodiments. Needless to say, the present invention should not be interpreted so as to be limited to the above-mentioned embodiments, and, of course, modification and improvement can be made suitably.

### EXAMPLE

Hereafter, preferable examples suitable as an optical element mentioned above will be described. Here, Examples 1 to 12 correspond to the first objective lens section or the second objective lens section respectively, and the optical element of the present invention can be obtained by combining two objective lens sections of Examples 1 12 arbitrarily within a range satisfying the conditions of the present invention. Further, hereafter (including lens in a table), it is assumed that the number of ten's power (for example, 2.5×10⁻³) is represented by the use of E (for example, 2.5E-3).

The optical surfaces of a objective optical system is shaped in an aspheric surface which are specified with a mathematical formula in which coefficients shown in Tables are substituted in Formula 1 respectively, and are axisymmetrical around an optical axis.

$$X ( h ) = \frac{( {h}^{2} / r )}{1 + \sqrt{1 - ( 1 + κ ) {( h / r )}^{2 }}} + {\sum }_{i = 0}^{10} {A}_{2 i} {h}^{2 i} \qquad [ Formula 1 ]$$

Here, X(h) represents an axis in a direction of an optical axis (a sign in the case of an advancing direction of a light flux is positive), k represents a constant of a cone, A₂ᵢ represents an aspheric surface coefficient, and h represents a height from an optical axis.

Further, in the case of an example employing a diffractive structure (phase structure), an optical path difference provided to a light flux of each wavelength by the diffractive structure is specified with a mathematical formula in which coefficients shown in Tables are substituted in an optical path difference function of Formula 2.

$$Φ ( h ) = λ / {λ}_{B} \times dor \times {\sum }_{i = 0}^{5} {C}_{2 i} {h}^{2 i} \qquad [ Formula 2 ]$$

λ represents a wavelength of an incident light flux, λ_{B} is a design wavelength (blazed wavelength), dor represents a diffraction order, and C2 represents a coefficient of an optical path difference function.

### Example 1

The lens data of Example 1 are shown in Table 1.

TABLE 1
Example 1 Lens date
Focal length of an objective lens f = 1.177 mm
Image side numerical aperture NA: 0.85
Magnification m: 0

| i-th surface | ri | di(405 nm) | ni(405 nm) |
|---|---|---|---|
| 0 | | ∞ | |
| 1(aperture | | 0.0(φ2.0 mm) | |
| diaphragm | | | |
| diameter) | | | |
| 2 | 0.7963 | 1.550 | 1.560 |
| 3 | −1.1509 | 0.30 | |
| 4 | ∞ | 0.0875 | 1.620 |
| 5 | ∞ | | |

Second surface
Aspheric surface coefficient

| | |
|---|---|
| κ | −4.8378E−01 |
| A4 | 1.4106E−02 |
| A6 | −5.3245E−02 |
| A8 | 2.2174E−01 |
| A10 | −4.8680E−01 |
| A12 | 2.8973E−01 |
| A14 | 8.6801E−01 |
| A16 | −2.0359E+00 |
| A18 | 1.7350E+00 |
| A20 | −5.6828E−01 |

Third surface
Aspheric surface coefficient

| | |
|---|---|
| κ | −4.2920E+01 |
| A4 | 6.0060E−01 |
| A6 | −1.7200E+00 |
| A8 | 3.0209E+00 |
| A10 | −5.6444E+00 |
| A12 | 9.6667E+00 |
| A14 | −7.6066E+00 |

### Example 2

The lens data of Example 2 are shown in Table 2.

TABLE 2
Example 2 Lens date
Focal length of an objective lens f = 1.177 mm
Image side numerical aperture NA: 0.85
Magnification m: 0

| i-th surface | ri | di(405 nm) | ni(405 nm) |
|---|---|---|---|
| 0 | | ∞ | |
| 1(aperture | | 0.0(φ2.0 mm) | |
| diaphragm | | | |
| diameter) | | | |
| 2 | 0.7955 | 1.550 | 1.560 |
| 3 | −1.1537 | 0.30 | |
| 4 | ∞ | 0.0875 | 1.620 |
| 5 | ∞ | | |

Second surface
Aspheric surface coefficient

| | |
|---|---|
| κ | −4.8462E−01 |
| A4 | 1.5162E−02 |
| A6 | −5.2457E−02 |
| A8 | 2.2147E−01 |
| A10 | −4.8708E−01 |
| A12 | 2.8995E−01 |
| A14 | 8.6854E−01 |
| A16 | −2.0355E+00 |
| A18 | 1.7349E+00 |
| A20 | −5.6932E−01 |

Third surface
Aspheric surface coefficient

| | |
|---|---|
| κ | −4.5209E+01 |
| A4 | 5.9295E−01 |
| A6 | −1.7229E+00 |
| A8 | 3.0352E+00 |
| A10 | −5.6247E+00 |
| A12 | 9.6229E+00 |
| A14 | −7.6066E+00 |

### Example 3

The lens data of Example 3 are shown in Table 3.

TABLE 3
Example 3 Lens date
Focal length of an objective lens f = 1.539 mm
Image side numerical aperture NA: 0.65
Magnification m: 0

| i-th surface | ri | di(405 nm) | ni(405 nm) |
|---|---|---|---|
| 0 | | ∞ | |
| 1(aperture | | 0.0(φ2.0 mm) | |
| diaphragm | | | |
| diameter) | | | |
| 2 | 1.0146 | 1.100 | 1.560 |
| 3 | −3.4957 | 0.57 | |
| 4 | ∞ | 0.6 | 1.620 |
| 5 | ∞ | | |

Second surface
Aspheric surface coefficient

| | |
|---|---|
| κ | −3.3563E−01 |
| A4 | −1.3585E−02 |
| A6 | −6.2003E−02 |
| A8 | 2.4885E−01 |
| A10 | −4.9967E−01 |
| A12 | 3.0584E−01 |
| A14 | 8.2708E−01 |
| A16 | −2.0627E+00 |
| A18 | 1.7678E+00 |
| A20 | −5.3523E−01 |

Third surface
Aspheric surface coefficient

| | |
|---|---|
| κ | 1.1826E+01 |
| A4 | 1.6081E−01 |
| A6 | 1.0186E−01 |
| A8 | 2.2975E−01 |
| A10 | −2.3692E+00 |
| A12 | 4.5813E+00 |
| A14 | −2.6495E+00 |

### Example 4

The lens data of Example 4 are shown in Table 4.

TABLE 4
Example 4 Lens date
Focal length of an objective lens f = 1.539 mm
Image side numerical aperture NA: 0.65
Magnification m: 0

| i-th surface | ri | di(405 nm) | ni(405 nm) |
|---|---|---|---|
| 0 | | ∞ | |
| 1(aperture | | 0.0(φ2.0 mm) | |
| diaphragm | | | |
| diameter) | | | |
| 2 | 0.9840 | 1.100 | 1.560 |
| 3 | −4.1517 | 0.55 | |
| 4 | ∞ | 0.6 | 1.620 |
| 5 | ∞ | | |

Second surface
Aspheric surface coefficient

| | |
|---|---|
| κ | −3.4042E−01 |
| A4 | −1.2304E−02 |
| A6 | −7.0169E−02 |
| A8 | 2.4974E−01 |
| A10 | −4.9730E−01 |
| A12 | 3.0635E−01 |
| A14 | 8.2678E−01 |
| A16 | −2.0627E+00 |
| A18 | 1.7676E+00 |
| A20 | −5.3497E−01 |

Third surface
Aspheric surface coefficient

| | |
|---|---|
| κ | 1.5444E+01 |
| A4 | 1.3094E−01 |
| A6 | 9.8928E−02 |
| A8 | 2.4707E−01 |
| A10 | −2.3437E+00 |
| A12 | 4.5978E+00 |
| A14 | −2.7444E+00 |

### Example 5

The lens data of Example 5 are shown in Table 5.

TABLE 5
Example 5 Lens date
Focal length of an objective lens f = 1.539 mm
Image side numerical aperture NA: 0.65
Magnification m: 0

| i-th surface | ri | di(658 nm) | ni(658 nm) |
|---|---|---|---|
| 0 | | ∞ | |
| 1(aperture | | 0.0(φ2.0 mm) | |
| diaphragm | | | |
| diameter) | | | |
| 2 | 0.9910 | 1.100 | 1.541 |
| 3 | −3.1596 | 0.56 | |
| 4 | ∞ | 0.6 | 1.577 |
| 5 | ∞ | | |

Second surface
Aspheric surface coefficient

| | |
|---|---|
| κ | −3.0908E−01 |
| A4 | −6.7389E−03 |
| A6 | −6.6934E−02 |
| A8 | 2.7122E−01 |
| A10 | −5.2473E−01 |
| A12 | 2.7394E−01 |
| A14 | 8.4948E−01 |
| A16 | −2.0246E+00 |
| A18 | 1.7690E+00 |
| A20 | −5.4627E−01 |

Third surface
Aspheric surface coefficient

| | |
|---|---|
| κ | 1.1435E+01 |
| A4 | 2.5577E−01 |
| A6 | 9.5919E−02 |
| A8 | −2.2086E−01 |
| A10 | −1.7716E+00 |
| A12 | 5.6138E+00 |
| A14 | −3.9396E+00 |

### Example 6

The lens data of Example 6 are shown in Table 6.

TABLE 6
Example 6 Lens date
Focal length of an objective lens f = 1.539 mm
Image side numerical aperture NA: 0.65
Magnification m: 0

| i-th surface | ri | di(658 nm) | ni(658 nm) |
|---|---|---|---|
| 0 | | ∞ | |
| 1(aperture | | 0.0(φ2.0 mm) | |
| diaphragm | | | |
| diameter) | | | |
| 2 | 0.9609 | 1.100 | 1.541 |
| 3 | −3.7025 | 0.54 | |
| 4 | ∞ | 0.6 | 1.577 |
| 5 | ∞ | | |

Second surface
Aspheric surface coefficient

| | |
|---|---|
| κ | −3.3224E−01 |
| A4 | −6.8524E−03 |
| A6 | −7.3073E−02 |
| A8 | 2.7543E−01 |
| A10 | −5.1979E−01 |
| A12 | 2.6983E−01 |
| A14 | 8.3889E−01 |
| A16 | −2.0362E+00 |
| A18 | 1.7709E+00 |
| A20 | −5.3737E−01 |

Third surface
Aspheric surface coefficient

| | |
|---|---|
| κ | 1.1519E+01 |
| A4 | 2.0782E−01 |
| A6 | 8.9414E−02 |
| A8 | −1.9344E−01 |
| A10 | −1.8725E+00 |
| A12 | 5.3174E+00 |
| A14 | −3.6083E+00 |

### Example 7

The lens data of Example 7 are shown in Table 7.

TABLE 7
Example 7 Lens date
Focal length of an objective lens f = 2.000 mm
Image side numerical aperture NA: 0.50
Magnification m: 0

| i-th surface | ri | di(785 nm) | ni(785 nm) |
|---|---|---|---|
| 0 | | ∞ | |
| 1(aperture | | 0.0 (φ2.0 mm) | |
| diaphragm | | | |
| diameter) | | | |
| 2 | 1.2581 | 1.000 | 1.537 |
| 3 | −5.3176 | 0.68 | |
| 4 | ∞ | 1.2 | 1.571 |
| 5 | ∞ | | |

Second surface
Aspheric surface coefficient

| | |
|---|---|
| κ | −4.7543E−01 |
| A4 | 1.2336E−02 |
| A6 | 6.9341E−03 |
| A8 | −1.1294E−03 |
| A10 | 6.2909E−03 |
| A12 | 2.7099E−03 |
| A14 | 6.1014E−03 |

Third surface
Aspheric surface coefficient

| | |
|---|---|
| κ | −4.9265E+01 |
| A4 | 4.8273E−02 |
| A6 | −5.5475E−03 |
| A8 | −1.5850E−02 |
| A10 | 7.5991E−02 |
| A12 | 5.9877E−02 |
| A14 | −7.6346E−02 |

### Example 8

The lens data of Example 8 are shown in Table 8.

TABLE 8
Example 8 Lens date
Focal length of an objective lens f = 2.000 mm
Image side numerical aperture NA: 0.50
Magnification m: 0

| i-th surface | ri | di(785 nm) | ni(785 nm) |
|---|---|---|---|
| 0 | | ∞ | |
| 1(aperture | | 0.0(φ2.0 mm) | |
| diaphragm | | | |
| diameter) | | | |
| 2 | 1.2467 | 1.000 | 1.537 |
| 3 | −5.5987 | 0.68 | |
| 4 | ∞ | 1.2 | 1.571 |
| 5 | ∞ | | |

Second surface
Aspheric surface coefficient

| | |
|---|---|
| κ | −4.6496E−01 |
| A4 | 1.4076E−02 |
| A6 | 7.4180E−03 |
| A8 | −3.0319E−03 |
| A10 | 4.1049E−03 |
| A12 | 1.3390E−03 |
| A14 | 5.8029E−03 |

Third surface
Aspheric surface coefficient

| | |
|---|---|
| κ | −7.0367E+01 |
| A4 | 4.9471E−02 |
| A6 | −9.9280E−03 |
| A8 | −2.4301E−02 |
| A10 | 6.3022E−02 |
| A12 | 5.0283E−02 |
| A14 | −6.0067E−02 |

### Example 9

The lens data of Example 9 are shown in Table 9.

TABLE 9
Example 9 Lens date

| | | |
|---|---|---|
| Focal length of an objective lens | f = 2.330 mm | f = 2.347 mm |
| Image side numerical aperture | NA: 0.60 | NA: 0.47 |
| Magnification | m: 0 | m: 0 |

| i-th | | di | ni | di | ni |
|---|---|---|---|---|---|
| surface | ri | (658 nm) | (658 nm) | (785 nm) | (785 nm) |
| 0 | | ∞ | | ∞ | |
| 1 (aperture | | 0.0 | | 0.0 | |
| diaphragm | | (φ2.80 mm) | | (φ2.19 mm) | |
| diameter) | | | | | |
| 2-1 | 1.5742 | 1.200 | 1.524 | 1.200 | 1.520 |
| 2-2 | 1.4202 | | | | |
| 3-1 | −6.0263 | | | | |
| 3-2 | −6.1349 | 1.27 | | 0.90 | |
| 4 | ∞ | 0.6 | 1.577 | 1.2 | 1.571 |
| 5 | ∞ | | | | |

Aspheric surface coefficient

Second-first surface (h ≧ 1.095 mm)

| | |
|---|---|
| κ | −7.5119E−01 |
| A0 | 1.2455E−02 |
| A4 | 4.5963E−02 |
| A6 | −2.3137E−02 |
| A8 | 8.3998E−03 |
| A10 | −1.3552E−03 |

Second-second surface (h ≦ 1.095 mm)

| | |
|---|---|
| κ | −2.3371E+00 |
| A0 | 0.0000E+00 |
| A4 | 7.1153E−02 |
| A6 | −2.5290E−02 |
| A8 | 1.1997E−02 |
| A10 | −2.0657E−03 |

Third-first surface (h ≧ 0.890 mm)

| | |
|---|---|
| κ | −4.4362E+01 |
| A0 | 2.6438E−03 |
| A4 | 5.9075E−03 |
| A6 | 2.7886E−03 |
| A8 | −5.1817E−03 |
| A10 | 1.0878E−02 |
| A12 | −1.2168E−02 |
| A14 | 5.6367E−03 |
| A16 | −9.4255E−04 |

Third-second surface (h ≦ 0.890 mm)

| | |
|---|---|
| κ | −3.0513E+01 |
| A0 | 0.0000E+00 |
| A4 | 4.6333E−03 |
| A6 | 6.3281E−03 |
| A8 | −1.6160E−03 |
| A10 | 9.3612E−03 |
| A12 | −1.2175E−02 |
| A14 | 5.6886E−03 |
| A16 | −9.6216E−04 |

Optical path difference function

| | |
|---|---|
| Diffraction order | 1/1 |
| Design wavelength | 658 nm |
| C1 | −2.8655E−03 |
| C2 | −1.9236E−03 |
| C3 | 2.1111E−03 |
| C4 | −2.9000E−03 |
| C5 | 8.5280E−04 |
| Diffraction order | 1/1 |
| Design wavelength | 680 nm |
| C1 | 0.0000E+00 |
| C2 | −3.3534E−03 |
| C3 | −3.7747E−03 |
| C4 | 2.3524E−03 |
| C5 | −6.8648E−04 |

### Example 10

The lens data of Example 10 are shown in Table 10.

TABLE 10
Example 10 Lens date

| | | |
|---|---|---|
| Focal length of an objective lens | f = 2.330 mm | f = 2.347 mm |
| Image side numerical aperture | NA: 0.60 | NA: 0.47 |
| Magnification | m: 0 | m: 0 |

| i-th | | di | ni | di | ni |
|---|---|---|---|---|---|
| surface | ri | (658 nm) | (658 nm) | (785 nm) | (785 nm) |
| 0 | | ∞ | | ∞ | |
| 1 (aperture | | 0.0 | | 0.0 | |
| diaphragm | | (φ2.80 mm) | | (φ2.19 mm) | |
| diameter) | | | | | |
| 2-1 | 1.5678 | 1.200 | 1.524 | 1.200 | 1.520 |
| 2-2 | 1.3958 | | | | |
| 3-1 | −6.7729 | | | | |
| 3-2 | −6.8078 | 1.26 | | 0.89 | |
| 4 | ∞ | 0.6 | 1.577 | 1.2 | 1.571 |
| 5 | ∞ | | | | |

Aspheric surface coefficient

Second-first surface (h ≧ 1.095 mm)

| | |
|---|---|
| κ | −7.2769E−01 |
| A0 | 1.2849E−02 |
| A4 | 4.6921E−02 |
| A6 | −2.2670E−02 |
| A8 | 8.6057E−03 |
| A10 | −1.2715E−03 |

Second-second surface (h ≦ 1.095 mm)

| | |
|---|---|
| κ | −2.2357E+00 |
| A0 | 0.0000E+00 |
| A4 | 7.4113E−02 |
| A6 | −2.3618E−02 |
| A8 | 1.1600E−02 |
| A10 | −2.8681E−03 |

Third-first surface (h ≧ 0.890 mm)

| | |
|---|---|
| κ | −5.2355E+01 |
| A0 | 1.3309E−03 |
| A4 | 6.9042E−03 |
| A6 | 3.0612E−03 |
| A8 | −5.2023E−03 |
| A10 | 1.0801E−02 |
| A12 | −1.2218E−02 |
| A14 | 5.6277E−03 |
| A16 | −9.2458E−04 |

Third-second surface (h ≦ 0.890 mm)

| | |
|---|---|
| κ | −5.8696E+01 |
| A0 | 0.0000E+00 |
| A4 | 7.6524E−03 |
| A6 | 3.9025E−03 |
| A8 | −4.4042E−03 |
| A10 | 7.2759E−03 |
| A12 | −1.0117E−02 |
| A14 | 5.6886E−03 |
| A16 | −9.6216E−04 |

Optical path difference function

| | |
|---|---|
| Diffraction order | 1/1 |
| Design wavelength | 658 nm |
| C1 | −4.0350E−03 |
| C2 | −2.1394E−03 |
| C3 | 2.1191E−03 |
| C4 | −2.8418E−03 |
| C5 | 9.0267E−04 |
| Diffraction order | 1/1 |
| Design wavelength | 680 nm |
| C1 | 0.0000E+00 |
| C2 | −3.2195E−03 |
| C3 | −3.9747E−03 |
| C4 | 2.4406E−03 |
| C5 | −7.5448E−04 |

### Example 11

The lens data of Example 11 are shown in Table 11.

TABLE 11
Example 11 Lens date

| | | | |
|---|---|---|---|
| Focal length of an objective lens | f = 2.300 mm | f = 2.406 mm | f = 2.393 mm |
| Image side numerical aperture | NA: 0.65 | NA: 0.67 | NA: 0.51 |
| Magnification | m: 1/22.3 | m: 1/24.8 | m: −1/31.0 |

| i-th | | di | ni | di | ni | di | ni |
|---|---|---|---|---|---|---|---|
| surface | ri | (408 nm) | (408 nm) | (660 nm) | (660 nm) | (784 nm) | (784 nm) |
| 0 | | −49.00 | | −57.38 | | 76.38 | |
| 1 (aperture | | 0.0 | | 0.0 | | 0.0 | |
| diaphragm | | (φ2.86 mm) | | (φ3.11 mm) | | (φ2.52 mm) | |
| diameter) | | | | | | | |
| 2-1 | 1.5342 | 1.370 | 1.558 | 1.370 | 1.539 | 1.370 | 1.536 |
| 2-2 | 1.5132 | | | | | | |
| 3 | −10.5245 | 1.02 | | 1.11 | | 0.89 | |
| 4 | ∞ | 0.6 | 1.618 | 0.6 | 1.577 | 1.2 | 1.571 |
| 5 | ∞ | | | | | | |

Aspheric surface coefficient

Second-first surface(h ≧ 1.410 mm)

| | |
|---|---|
| κ | −5.0723E−01 |
| A0 | 5.9726E−04 |
| A4 | 4.6067E−03 |
| A6 | 3.3604E−03 |
| A8 | 4.7713E−04 |
| A10 | −1.6583E−03 |
| A12 | 1.0226E−03 |
| A14 | −2.3616E−04 |

Second-second surface(h ≦ 1.410 mm)

| | |
|---|---|
| κ | −5.2440E−01 |
| A0 | 0.0000E+00 |
| A4 | 3.1278E−03 |
| A6 | 3.0595E−03 |
| A8 | 5.7433E−04 |
| A10 | −1.6889E−03 |
| A12 | 9.8200E−04 |
| A14 | −2.3092E−04 |

Third surface

| | |
|---|---|
| κ | −2.0751E+01 |
| A0 | 0.0000E+00 |
| A4 | 2.6828E−02 |
| A6 | −5.1703E−03 |
| A8 | −4.2399E−03 |
| A10 | 1.8250E−03 |
| A12 | −2.6491E−04 |
| A14 | 6.4302E−06 |

Optical path difference function

| | |
|---|---|
| Diffraction order | 5/3/2 |
| Design wavelength | 660 nm |
| C1 | −4.8721E−03 |
| C2 | −2.4521E−04 |
| C3 | 4.4832E−04 |
| C4 | −2.8720E−04 |
| C5 | 7.2567E−05 |
| Diffraction order | 2/1/1 |
| Design wavelength | 380 nm |
| C1 | −7.3258E−03 |
| C2 | −7.6030E−04 |
| C3 | 7.5887E−04 |
| C4 | −5.1161E−04 |
| C5 | 1.1114E−04 |

### Example 12

The lens data of Example 12 are shown in Table 12.

TABLE 12
Example 12 Lens date

| | | | |
|---|---|---|---|
| Focal length of an objective lens | f = 2.300 mm | f = 2.406 mm | f = 2.393 mm |
| Image side numerical aperture | NA: 0.65 | NA: 0.67 | NA: 0.51 |
| Magnification | m: 1/22.3 | m: 1/24.8 | m: −1/38.0 |

| i-th | | di | ni | di | ni | di | ni |
|---|---|---|---|---|---|---|---|
| surface | ri | (408 nm) | (408 nm) | (660 nm) | (660 nm) | (784 nm) | (784 nm) |
| 0 | | −49.00 | | −57.38 | | 93.21 | |
| 1 (aperture | | 0.0 | | 0.0 | | 0.0 | |
| diaphragm | | (φ2.86 mm) | | (φ3.11 mm) | | (φ2.52 mm) | |
| diameter) | | | | | | | |
| 2-1 | 1.5284 | 1.370 | 1.558 | 1.370 | 1.539 | 1.370 | 1.536 |
| 2-2 | 1.4900 | | | | | | |
| 3 | −12.5193 | 1.00 | | 1.10 | | 0.86 | |
| 4 | ∞ | 0.6 | 1.618 | 0.6 | 1.577 | 1.2 | 1.571 |
| 5 | ∞ | | | | | | |

Aspheric surface coefficient

Second-first surface(h ≧ 1.410 mm)

| | |
|---|---|
| κ | −4.9636E−01 |
| A0 | 1.1841E−03 |
| A4 | 5.5090E−03 |
| A6 | 3.6940E−03 |
| A8 | 5.1337E−04 |
| A10 | −1.6954E−03 |
| A12 | 1.0159E−03 |
| A14 | −2.3604E−04 |

Second-second surface(h ≦ 1.410 mm)

| | |
|---|---|
| κ | −5.2477E−01 |
| A0 | 0.0000E+00 |
| A4 | 3.2089E−03 |
| A6 | 2.9302E−03 |
| A8 | 4.8096E−04 |
| A10 | −1.6592E−03 |
| A12 | 1.0089E−03 |
| A14 | −2.5362E−04 |

Third surface

| | |
|---|---|
| κ | −1.3005E+01 |
| A0 | 0.0000E+00 |
| A4 | 2.6456E−02 |
| A6 | −5.2091E−03 |
| A8 | −4.5881E−03 |
| A10 | 1.8591E−03 |
| A12 | −2.2478E−04 |
| A14 | 1.2085E−06 |

Optical path difference function

| | |
|---|---|
| Diffraction order | 5/3/2 |
| Design wavelength | 660 nm |
| C1 | −5.0947E−03 |
| C2 | −3.4281E−04 |
| C3 | 4.3066E−04 |
| C4 | −2.7487E−04 |
| C5 | 8.2502E−05 |
| Diffraction order | 2/1/1 |
| Design wavelength | 380 nm |
| C1 | −7.3258E−03 |
| C2 | −8.6931E−04 |
| C3 | 7.0136E−04 |
| C4 | −5.0887E−04 |
| C5 | 1.1228E−04 |

Here, with reference to the above-mentioned examples 1 to 12, target optical disks and the value of |HCM|/|TCM| are summarized in the following Table 13.

TABLE 13

| | Target | | Conditional |
|---|---|---|---|
| Example | optical disk | \|HCM\|/\|TCM\| | formula |
| 1 | BD | 0.163 | (1) |
| 2 | BD | 0.429 | (2) |
| 3 | HD | 0.414 | (2) |
| 4 | HD | 0.056 | (1) |
| 5 | DVD | 0.038 | (1) |
| 6 | DVD | 0.883 | (2) |
| 7 | CD | 0.014 | (1) |
| 8 | CD | 0.450 | (2) |
| 9 | DVD/CD | 0.090(At the time | (1) |
| | compatible | of using DVD) | |
| 10 | DVD/CD | 0.449(At the time | (2) |
| | compatible | of using DVD) | |
| 11 | HD/DVD/CD | 0.002(At the time | (1) |
| | compatible | of using HD) | |
| 12 | HD/DVD/CD | 0.321(At the time | (2) |
| | compatible | of using HD) | |

As stated above, an optical element of the present invention can be obtained by combining two objective lenses in Examples 1 to 12 arbitrarily within a range satisfying the conditions of the present invention. For example, the combinations shown in the following Table 14 may be listed as preferable examples. However, the present invention is not limited to these examples.

TABLE 14

| | Target optical disk | Numbers of Examples |
|---|---|---|
| | (first objective lens | (first objective lens |
| | section-second | section-second |
| No. | objective lens section) | objective lens section) |
| 1 | BD-HD/DVD/CD | Example 2-Example 11 |
| 2 | BD-HD | Example 2-Example 4 |
| 3 | BD-DVD/CD | Example 1-Example 10 |
| 4 | HD-DVD/CD | Example 4-Example 10 |
| 5 | DVD-CD | Example 5-Example 8 |

1-24. (canceled)

25. An optical element for use in an optical pickup apparatus, comprising:
a first objective lens section;
a second objective lens section; and
a flange section to hold the first objective lens section and the second objective lens section in one body;
wherein one of the first objective lens section and the second objective lens section is adapted to satisfy the following conditional formula (1) and another one is adapted to satisfy the following conditional formula (2),

|HCM|/|TCM|<0.3 (1)

|HCM|/|TCM|>0.3 (2)
here, HCM represents a view angle third order coma sensibility, TCM represents a tilt angle third order coma sensibility, |HCM| and |TCM| in the conditional formula (1) are values on a light spot formed by the use of the one of the first objective lens section and the second objective lens section satisfying the conditional formula (1) respectively, and |HCM| and |TCM| in the conditional formula (2) are values on a light spot formed by the use of the another one satisfying the conditional formula (2) respectively.

26. The optical element described claim 25, wherein the optical pickup apparatus comprises a light source to emit one or more light fluxes and the optical element, and wherein the optical pickup apparatus converges a light flux from the light source through the first objective lens section onto a first information recording surface of a first optical information recording medium with a first protective substrate having a thickness t1 to conduct recording and/or reproducing information for the first information recording surface, and converges a light flux from the light source through the second objective lens section onto a second information recording surface of a second information recording medium with a protective substrate having a thickness t2 (t2≧t1) to conduct recording and/or reproducing information for the second information recording surface.

27. The optical element described in claim 26, wherein the first objective lens section is adapted to satisfy the conditional formula (1) and the second objective lens section is adapted to satisfy the conditional formula (2).

28. The optical element described in claim 26, wherein the first objective lens section is adapted to satisfy the conditional formula (2) and the second objective lens section is adapted to satisfy the conditional formula (1).

29. The optical element described in claim 26, wherein the light source is a first light source to emit a first light flux with a wavelength λ1, and wherein the optical pickup apparatus converges the first light flux through the first objective lens section onto a first information recording surface of the first optical information recording medium, and converges the first light flux through the second objective lens section onto a second information recording surface of the second information recording medium.

30. The optical element described in claim 29, wherein the following formulas (3) and (4) are satisfied.
0.03≦t1(mm)≦0.14 (3)
0.5≦t2(mm)≦0.8 (4)

31. The optical element described in claim 25, wherein the first objective lens section, the second objective lens section and the flange section are integrally molded in one body.

32. The optical element described in claim 25, wherein at least one of the first objective lens section and the second objective lens section is engaged with the flange section so that the first objective lens section, the second objective lens and the flange are made in one body.

33. The optical element described in claim 25, wherein an angle formed between the direction of the third order coma aberration of the first objective lens section and the direction of the third order coma aberration of the second objective lens section is 30 degrees or less.

34. The optical element described in claim 26, wherein the light source includes a first light source to emit a first light flux with a wave length of λ1 and a second light source to emit a second light flux with a wave length of λ2 (λ2>λ1), and
wherein the optical element is adapted to converge the first light flux through the first objective lens section onto the first information recording surface of the first optical information recording medium, to converge the first light flux through the second objective lens section onto the second information recording surface of the second optical information recording medium, and to converge the second light flux through the second objective lens section onto an information recording surface of a third optical information recording medium with a protective substrate having a thickness of t3 (t2≦t3), so that recording and/or reproducing information is conducted for the first, second and third information recording surfaces respectively.

35. The optical element described in claim 26, wherein the light source includes a first light source to emit a first light flux with a wave length of λ1, a second light source to emit a second light flux with a wave length of λ2 (λ2>λ1) and a third light source to emit a third light flux with a wave length of λ3 (λ3>λ2), and
wherein the optical element is adapted to converge the first light flux through the first objective lens section onto the first information recording surface of the first optical information recording medium, to converge the first light flux through the second objective lens section onto the second information recording surface of the second optical information recording medium, to converge the second light flux through the second objective lens section onto an information recording surface of a third optical information recording medium with a protective substrate having a thickness of t3 (t2≦t3), and to converge the third light flux through the second objective lens section onto an information recording surface of a fourth optical information recording medium with a protective substrate having a thickness of t4 (t3<t4), so that recording and/or reproducing information is conducted for the first, second, third and fourth information recording surfaces respectively.

36. The optical element described in claim 25, wherein at least one of the first objective lens section and the second objective lens section comprises a ring-shaped optical path difference providing structure.

37. An optical pickup apparatus, comprising:
a light source to emit one or more light fluxes, and
and an optical element in which a first objective lens section, a second objective lens section and a flange section are made in one body, the optical pickup apparatus converges a light flux from the light source through the first objective lens section onto an information recording surface of a first optical information recording medium with a protective substrate having a thickness of t1 so as to conduct recording and/or reproducing information for the information recording surface, and converges a light flux from the light source through the second objective lens section onto an information recording surface of a second optical information recording medium with a protective substrate having a thickness of t2 (t2≦t1) so as to conduct recording and/or reproducing information for the information recording surface,
wherein the optical pickup apparatus further comprises a relative tilt changing section to change a relative tilt between the optical element and the first optical information recording medium or the second optical information recording medium, and one of the first objective lens section and the second objective lens section satisfies the following conditional formula (1) and another one satisfies the following conditional formula (2),

|HCM|/|TCM|<0.3 (1)

|HCM|/|TCM|>0.3 (2)
here, HCM represents a view angle third order coma sensibility, TCM represents a tilt angle third order coma sensibility, |HCM| and |TCM| in the conditional formula (1) are values on a light spot formed by the use of the one of the first objective lens section and the second objective lens section satisfying the conditional formula (1) respectively, and |HCM| and |TCM| in the conditional formula (2) are values on a light spot formed by the use of the another one satisfying the conditional formula (2) respectively.

38. The optical pickup apparatus described in claim 37, wherein the first objective lens section is adapted to satisfy the conditional formula (1) and the second objective lens section is adapted to satisfy the conditional formula (2).

39. The optical pickup apparatus described in claim 37, wherein the first objective lens section is adapted to satisfy the conditional formula (2) and the second objective lens section is adapted to satisfy the conditional formula (1).

40. The optical pickup apparatus described in claim 37, wherein the light source is a first light source to emit a first light flux with a wavelength λ1, and wherein the optical pickup apparatus converges the first light flux through the first objective lens section onto a first information recording surface of the first optical information recording medium, and converges the first light flux through the second objective lens section onto a second information recording surface of the second information recording medium.

41. The optical pickup apparatus described in claim 40, wherein the following
formulas (3) and (4) are satisfied.
0.03≦t1(mm)≦0.14 (3)
0.5≦t2(mm)≦0.8 (4)

42. The optical pickup apparatus described in claim 37, wherein the first objective lens section, the second objective lens section and the flange section are integrally molded in one body.

43. The optical pickup apparatus described in claim 37, wherein at least one of the first objective lens section and the second objective lens section is engaged with the flange section so that the first objective lens section, the second objective lens and the flange are made in one body.

44. The optical pickup apparatus described in claim 37, wherein an angle formed between the direction of the third order coma aberration of the first objective lens section and the direction of the third order coma aberration of the second objective lens section is 30 degrees or less.

45. The optical pickup apparatus described in claim 37, wherein the light source includes a first light source to emit a first light flux with a wave length of λ1 and a second light source to emit a second light flux with a wave length of λ2 (λ2>λ1), and
wherein the optical pickup apparatus is adapted to converge the first light flux through the first objective lens section onto the first information recording surface of the first optical information recording medium, to converge the first light flux through the second objective lens section onto the second information recording surface of the second optical information recording medium, and to converge the second light flux through the second objective lens section onto an information recording surface of a third optical information recording medium with a protective substrate having a thickness of t3 (t2≦3), so that recording and/or reproducing information is conducted for the first, second and third information recording surfaces respectively.

46. The optical pickup apparatus described in claim 37, wherein the light source includes a first light source to emit a first light flux with a wave length of λ1, a second light source to emit a second light flux with a wave length of λ2 (λ2>λ1) and a third light source to emit a third light flux with a wave length of λ3 (λ3>λ2), and
wherein the optical pickup apparatus is adapted to converge the first light flux through the first objective lens section onto the first information recording surface of the first optical information recording medium, to converge the first light flux through the second objective lens section onto the second information recording surface of the second optical information recording medium, to converge the second light flux through the second objective lens section onto an information recording surface of a third optical information recording medium with a protective substrate having a thickness of t3 (t2≦t3), and to converge the third light flux through the second objective lens section onto an information recording surface of a fourth optical information recording medium with a protective substrate having a thickness of t4 (t3<t4), so that recording and/or reproducing information is conducted for the first, second, third and fourth information recording surfaces respectively.

47. The optical pickup apparatus described in claim 37, wherein at least one of the first objective lens section and the second objective lens section comprises a ring-shaped optical path difference providing structure.

48. An assembling method of an optical pickup apparatus which comprises a light source to emit one or more light fluxes and an optical element in which a first objective lens section and a second objective lens section are made in one body, wherein the optical pickup apparatus converges a light flux from the light source through the first objective lens section onto an information recording surface of a first optical information recording medium with a protective substrate having a thickness of t1 so as to conduct recording and/or reproducing information for the information recording surface, and converges a light flux from the light source through the second objective lens section onto an information recording surface of a second optical information recording medium with a protective substrate having a thickness of t2 (t2>t1) so as to conduct recording and/or reproducing information for the information recording surface, and one of the first objective lens section and the second objective lens section satisfies the following conditional formula (1) and another one satisfies the following conditional formula (2), the assembling method of an optical pickup apparatus, comprising:
a step of adjusting an tilt of the optical element so as to reduce a coma aberration of a converged light spot when a light flux from the light source is converged onto an information recording surface of the first information recording medium through the objective lens section satisfying the conditional formula (1) among the first objective lens section and the second objective lens section; and
a step of conducting a shift adjusting process for the light source so as to reduce a coma aberration of a converged light spot when a light flux from the light source is converged onto an information recording surface of the second information recording medium through the objective lens section satisfying the conditional formula (2) among the first objective lens section and the second objective lens section,

|HCM|/|TCM|<0.3 (1)

|HCM|/|TCM|>0.3 (2)
wherein HCM represents a view angle third order coma sensibility, TCM represents a tilt angle third order coma sensibility, |HCM| and |TCM| in the conditional formula (1) are values on a light spot formed by the use of the one of the first objective lens section and the second objective lens section satisfying the conditional formula (1) respectively, and |HCM| and |TCM| in the conditional formula (2) are values on a light spot formed by the use of the another one satisfying the conditional formula (2) respectively.
